(19) United States
(12) Patent Application Publication
(10) Pub. No.: US 2026/0288832 A1
(43) Pub. Date: Sep. 24, 2026

(54) SYSTEM

(71) Applicant: SoftBank Group Corp., Tokyo (JP)

(72) Inventor: Yuki OTA, Tokyo (JP)

(73) Assignee: SoftBank Group Corp., Tokyo (JP)

(21) Appl. No.: 19/567,509

(22) Filed: Mar. 16, 2026

(30) Foreign Application Priority Data
Mar. 19, 2025 (JP) 2025-045082

(51) Int. Cl. G06F 16/334; G06F 16/3332; G06F 16/335

(52) U.S. Cl. CPC G06F 16/3344; G06F 16/3334; G06F 16/337

(57) ABSTRACT

A system includes a processor that is configured to receive a question from a user and analyze the question by using a natural language processing technique to extract one or more important keywords from the question, create, by using the extracted one or more keywords, a prompt that instructs a generative artificial intelligence model to generate an answer, and input the prompt to the generative artificial intelligence model, obtain one or more answer candidates generated by the generative artificial intelligence model and provide the one or more answer candidates to the user, analyze an emotional state of the user by using an emotion engine that is configured to recognize an emotion of the user, and select an optimal answer for the user from the one or more answer candidates by using a machine learning algorithm.

### CROSS-REFERENCE TO RELATED APPLICATION

This application is based on and claims priority under 35 USC 119 from Japanese Patent Application No. 2025-045082 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional question answering systems that utilize natural language processing techniques and generative artificial intelligence models suffer from several problems. First, such systems often rely solely on text-based analysis of user input and do not adequately consider the emotional state of the user, resulting in answers that may be technically correct but are not appropriate in tone, level of detail, or style for the user's current emotional condition. Second, although generative artificial intelligence models can produce multiple answer candidates, conventional systems typically do not include a robust mechanism for evaluating these answer candidates and selecting an optimal answer in a manner that reflects both the semantic relevance to the user's question and the user's emotional state. Third, existing systems frequently lack an integrated architecture in which the processes of keyword extraction, prompt generation for a generative artificial intelligence model, emotional state analysis, and machine learning-based answer selection are coordinated by a single processor in a consistent workflow. As a result, users may receive answers that are inconsistent in quality, insensitive to user emotion, and suboptimal in terms of relevance and usefulness. Accordingly, there is a need for a system that can receive a question from a user, analyze the question using natural language processing, generate one or more answer candidates using a generative artificial intelligence model, analyze the emotional state of the user, and automatically select an optimal answer by using a machine learning algorithm that takes into account both the content of the question and the emotional context of the user.

### SUMMARY

In order to solve the above-described problems, a system is provided comprising a processor configured to execute an integrated series of processing steps. The processor is configured to receive a question from a user and analyze the question by using a natural language processing technique to extract one or more important keywords from the question. The processor is further configured to create, on the basis of the extracted keywords, a prompt that instructs a generative artificial intelligence model to generate an answer, and to input the prompt to the generative artificial intelligence model. The processor is configured to obtain one or more answer candidates generated by the generative artificial intelligence model and to provide the one or more answer candidates to the user. In addition, the processor is configured to analyze an emotional state of the user by using an emotion engine that is configured to recognize an emotion of the user, for example by analyzing user utterances, text expressions, or other interaction-related features. The processor is further configured to evaluate the one or more answer candidates and to select an optimal answer for the user from the one or more answer candidates by using a machine learning algorithm that can consider at least the content of the question, characteristics of each answer candidate, and the emotional state of the user. In some embodiments, the processor is configured to automatically generate an answer to the question from the user by inputting, to the generative artificial intelligence model, the prompt that instructs the generative artificial intelligence model to generate the answer and causing the generative artificial intelligence model to generate the answer. In other embodiments or in combination, the processor is configured to evaluate the plurality of answer candidates generated in response to the question from the user and to select the optimal answer from the plurality of answer candidates by using the machine learning algorithm. Through these configurations, the system can provide answers that are both semantically appropriate and emotionally adaptive, thereby improving user satisfaction and the effectiveness of the interaction.

The term “system” refers to an information processing apparatus, which may be implemented by one or more physical or virtual machines, configured to execute the functions described in the present specification and claims.

The term “processor” refers to one or more hardware processing units, such as a central processing unit (CPU), a graphics processing unit (GPU), or another computation device, or a combination thereof, configured to execute computer-executable instructions and implement the described functions.

The term “user” refers to a human operator or end user who inputs a question to the system and receives an answer from the system.

The term “question” refers to an input expression, typically in natural language text or speech converted to text, provided by the user to request information, clarification, or guidance from the system.

The term “natural language processing technique” refers to a software-based method or algorithm for analyzing and processing natural language text, including but not limited to tokenization, part-of-speech tagging, syntactic parsing, semantic analysis, intent detection, and keyword extraction.

The term “keyword” refers to an important word or phrase extracted from the question by the natural language processing technique and used to characterize the meaning or topic of the question.

The term “generative artificial intelligence model” refers to a machine learning model, such as a large language model or neural network-based text generation model, configured to generate natural language text, including answers or answer candidates, in response to input data or prompts.

The term “prompt” refers to an input text or structured instruction that is provided to the generative artificial intelligence model to specify or constrain the content, style, or purpose of an answer to be generated.

The term “answer candidate” refers to a potential answer generated by the generative artificial intelligence model in response to the prompt and subject to subsequent evaluation or selection by the system.

The term “emotion engine” refers to a software component or module configured to recognize or estimate an emotional state of the user based on user-related data, such as text content, voice characteristics, facial expressions, or interaction patterns.

The term “emotional state” refers to a condition or category representing the user's emotion, such as happiness, frustration, confusion, satisfaction, or other affective states, as estimated by the emotion engine.

The term “machine learning algorithm” refers to a computational algorithm, model, or framework that is trained on data and configured to perform tasks such as classification, regression, ranking, or scoring, and is used by the processor to evaluate answer candidates and select an optimal answer.

The term “optimal answer” refers to an answer selected from among a plurality of answer candidates that best satisfies one or more selection criteria, such as semantic relevance to the question, appropriateness to the user's emotional state. clarity, and usefulness.

The term “analyze the question” refers to performing one or more natural language processing techniques on the question to identify structure, meaning, intent, or keywords contained in the question.

The term “create a prompt” refers to generating, by the processor, a text or structured input based on the extracted keywords and other analysis results, the prompt being suitable for instructing the generative artificial intelligence model to generate an answer.

The term “provide the one or more answer candidates to the user” refers to outputting the generated answer candidates via a user interface, such as displaying the text on a screen or otherwise presenting the answer candidates in a perceptible form to the user.

The term “evaluate the one or more answer candidates” refers to computing, by the processor using the machine learning algorithm or other evaluation logic, one or more metrics or scores indicating the quality, relevance, or suitability of each answer candidate.

The term “automatically generate an answer” refers to causing the generative artificial intelligence model to produce an answer without requiring manual intervention from an operator, based on the prompt created by the processor.

The term “integrated series of processing steps” refers to a sequence of operations, including question reception, natural language processing, prompt generation, answer generation, emotional state analysis, and machine learning-based answer selection, that are executed in a coordinated manner by the processor within the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

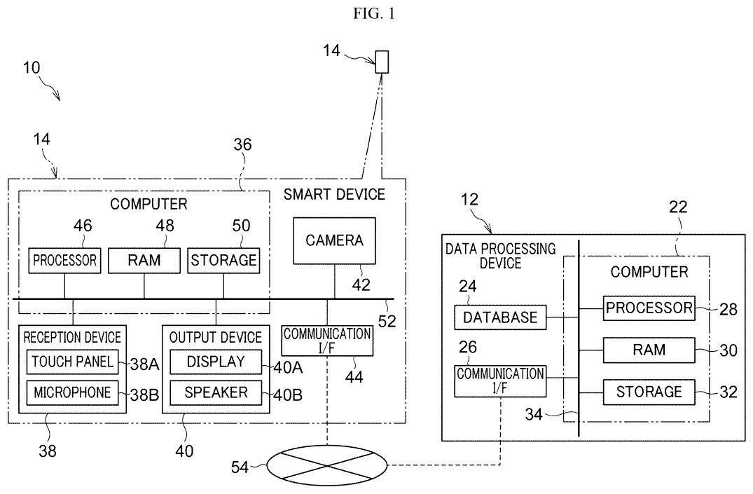

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

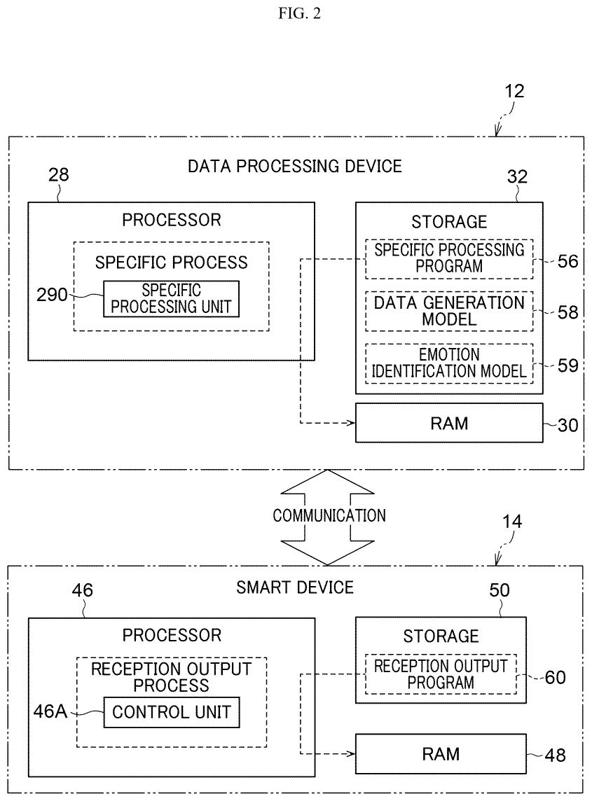

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented question answering systems that utilize generative AI models typically relay a user's natural language question directly to a remote model endpoint and return the raw model output to a terminal. Such systems have several technical drawbacks from the perspective of computer technology.

First, conventional systems generally fail to construct prompt sentences in a structured and systematic manner that reflect both the current question and the accumulated interaction history. As a result, the generative AI model is invoked with incomplete conversational context, which leads to unstable answer quality and increased need for repeated user queries. This causes unnecessary invocation of the generative AI model and increased network and processor load on the server side.

Second, conventional systems usually do not integrate a machine learning-based evaluation pipeline on the server for dynamically controlling the output format or selection of answer candidates. Model-generated text is often returned as-is, without server-side evaluation of answer quality based on the specific question or conversational history. This leads to inefficient utilization of computational resources, because the server cannot prioritize or adapt the server-to-terminal data transmission based on answer relevance or reliability.

Third, conventional systems typically do not provide the user terminal with explicit identification information indicating that a displayed answer is generated by a generative AI model, nor do they transmit evaluation information computed by a server-side machine learning algorithm. From a human-computer interaction perspective, this limits the usability of the client-side interface, because the user cannot distinguish between system-generated and other types of content, and cannot use the server's evaluation information to decide how to act on the answer. As a consequence, users may perform redundant queries or manual verification steps, which again increases unnecessary network traffic and processing cycles.

Fourth, existing implementations do not optimize the integration between the input device, the server, and the generative AI model as a coordinated system. Question capture, prompt construction, model invocation, answer evaluation, and answer presentation are often implemented as loosely coupled components. This fragmented architecture leads to increased latency, redundant data processing (such as repeated parsing and normalization of the same question), and overhead in the communication protocol between the terminal and server.

Accordingly, there is a need for an improved computer-implemented system that: (i) constructs structured prompt sentences including conversational history for a generative AI model; (ii) performs server-side machine learning-based evaluation of generated answer candidates and controls the output format based on evaluation results; and (iii) provides the terminal with identification information and evaluation information in a unified response, so that the user can efficiently utilize the generated answers. By addressing these issues, it is possible to improve the technical performance of the overall question answering system in terms of processing efficiency, resource utilization, and response quality.

The specific processing by the specific processing unit 290 of the data processing device 12 in Example 1 is realized by the following means.

The present invention provides a server comprising a processor configured to receive, via a communication network, communication data including a question expressed in a natural language and acquired as character information by an input device, to extract the question from the communication data, to construct a prompt sentence including instruction text defining answer generation conditions and a plurality of message sequences representing history information for the question and a plurality of prior questions and answer candidates, to input the prompt sentence to a generative information processing model, to receive an answer candidate generated by the generative information processing model based on the prompt sentence, to apply a machine learning algorithm to the question and the answer candidate to calculate evaluation information representing quality or suitability of the answer candidate, to generate response data including the answer candidate, identification information indicating that the answer candidate is generated by the generative information processing model, and the evaluation information, and to transmit the response data to the input device via the communication network. This enables an integrated computer-implemented question answering system in which the server systematically constructs context-aware prompt sentences, performs server-side machine learning-based evaluation and output control for model-generated answer candidates, and returns enriched response data to the terminal so as to improve processing efficiency, resource utilization, and answer usability from the standpoint of computer technology.

The term “processor” refers to any hardware or combination of hardware and software that executes instructions to perform data processing operations, including but not limited to a central processing unit, a graphics processing unit, a microcontroller, a digital signal processor, or a virtualized processing resource in a networked computing environment.

The term “input device” refers to any component or subsystem that acquires data from a user or an external source and converts the data into electronic signals, including but not limited to a keyboard, a pointing device, a touch screen, a microphone, a camera, or a software-based user interface element such as a text input field.

The term “question” refers to information expressed in a natural language that represents a request for information, an explanation, or guidance, and that is formatted as character information suitable for processing by the system.

The term “character information” refers to data representing textual content in a machine-readable encoding, including but not limited to sequences of characters encoded in formats such as Unicode or ASCII.

The term “communication data” refers to data structures or messages that include at least a question and are formatted for transmission over a communication network using one or more communication protocols.

The term “communication network” refers to any wired or wireless infrastructure that enables electronic data exchange between devices, including but not limited to the Internet, a local area network, a wide area network, a cellular network, or a combination thereof.

The term “server” refers to any computing apparatus or group of computing apparatuses configured to provide services, data processing, or resource management to one or more remote devices via a communication network.

The term “prompt sentence” refers to a structured text input that is provided to a generative information processing model and that includes at least an instruction text defining answer generation conditions and a question, and optionally additional context information or message sequences.

The term “instruction text” refers to text that specifies conditions, constraints, roles, styles, or other behavioral parameters that guide how a generative information processing model should generate an answer candidate.

The term “generative information processing model” refers to a machine learning model configured to generate output data, such as natural language text, in response to an input prompt, and includes but is not limited to a generative AI model based on neural network architectures such as transformer models.

The term “answer candidate” refers to information, typically in the form of character information, generated by a generative information processing model in response to a prompt sentence and representing a proposed answer to a corresponding question.

The term “natural language processing” refers to computational techniques and algorithms for analyzing, interpreting, generating, or transforming human languages expressed as textual or speech data.

The term “response data” refers to data structures or messages generated by the server that include at least an answer candidate and are formatted for transmission to an input device via a communication network.

The term “display device” refers to any hardware or software component that visually presents information to a user, including but not limited to a liquid crystal display, an organic light-emitting diode display, a projection display, or a graphical user interface window.

The term “machine learning algorithm” refers to a computational method that adjusts internal parameters or applies learned models based on data to perform tasks such as classification, regression, ranking, or scoring, and that is used to evaluate or control answer candidates.

The term “evaluation information” refers to data representing a result of applying a machine learning algorithm to a question and an answer candidate, including but not limited to scores, rankings, labels, or confidence values indicative of quality, relevance, or suitability.

The term “output format” refers to characteristics of how an answer candidate is provided to an input device or user, including but not limited to text structure, level of detail, layout, additional annotations, or inclusion or exclusion of certain content.

The term “storage device” refers to any hardware or virtualized resource that stores data in a non-transitory manner, including but not limited to semiconductor memory, magnetic storage, optical storage, or network-attached storage.

The term “history information” refers to stored data representing past interactions between a user and the system, including but not limited to prior questions, prior answer candidates, associated timestamps, and related metadata.

The term “message sequence” refers to an ordered collection of messages that includes one or more questions, answer candidates, or instruction texts, and that is used as part of a prompt sentence to provide conversational context to a generative information processing model.

The term “conversational context” refers to information derived from one or more prior interactions in a sequence of communications, which influences the interpretation of a current question and the generation of a corresponding answer candidate.

The term “identification information” refers to data that indicates a property or origin of another piece of data, and in particular, data that indicates that an answer candidate is generated by a generative information processing model.

In one embodiment, a server, a terminal, and a user cooperate to implement a system that generates and evaluates natural language answer candidates by using a generative AI model based on a neural network architecture. The server executes computer programs on one or more processors, such as central processing units and graphics processing units, operating under control of an operating system such as a general-purpose server operating system. The terminal executes client-side programs, such as a web browser or a native application, on a processor of a personal computing device, such as a smartphone, a tablet, or a notebook computer. The user operates the terminal to input questions and to consume answer candidates displayed by the terminal.

The terminal acquires a question from the user via an input device. The terminal presents a graphical user interface including a text input component, such as an editable text box, and acquires text typed by the user through a hardware keyboard or a software keyboard displayed on a touch-sensitive panel. The terminal converts the acquired question into character information encoded in a character encoding format, such as a Unicode-based encoding, and stores the character information in a memory of the terminal.

The terminal constructs communication data that includes at least the question and, in some embodiments, metadata such as a user identifier, a timestamp, and a conversation identifier. The terminal structures the communication data as a data object, for example by organizing fields for the question text and the metadata. The terminal then generates packets according to a transport protocol stack, such as a combination of a hypertext transfer protocol over a transmission control protocol and an internet protocol, and transmits the communication data to the server via a communication network such as the Internet or a wireless mobile network.

The server receives the communication data from the terminal through a network interface.

The server parses headers and payloads of the incoming packets, reassembles the communication data, and extracts the question as character information. The server normalizes the question, for example by converting full-width characters to half-width characters, unifying newline representations, and applying lowercasing or language-specific normalization. The server may store the normalized question in a storage device, such as a non-transitory semiconductor memory or a magnetic disk, together with the metadata to form history information.

The server constructs a prompt sentence that is input to a generative information processing model. The server generates an instruction text that defines conditions for answer generation, such as style, level of detail, and permissible information sources. The server then selects a set of message sequences from the history information, including prior questions and prior answer candidates associated with a conversation identifier. The server concatenates the instruction text, the selected message sequences, and the normalized question in a predetermined format to form the prompt sentence. For example, the server may construct a prompt sentence such as:
“You are an assistant that explains internal policies and procedures to new personnel in clear and concise language. Answer step-by-step when describing procedures.

[User]: What is the procedure for expense reimbursement?

[Assistant]: The procedure for expense reimbursement is as follows:

[User]: Provide additional information related to expense reimbursement, including typical approval flows and documents required.”

In another example, the server may construct a prompt sentence such as:
“You are an assistant that teaches basic business concepts to personnel without prior experience.

[User]: Please explain the basic concepts of project management.”

In yet another example, the server may construct a prompt sentence such as:
“You are an assistant that explains internal procedures. Answer based only on general enterprise best practices when no specific rule is provided.

[User]: If a new employee wants to know the procedure for expense reimbursement, how would you explain it in simple terms?”

The server converts the prompt sentence into a token sequence using a tokenizer associated with the generative information processing model. The server then inputs the token sequence and model parameters to the generative information processing model. The generative information processing model is implemented as a multi-layer neural network conforming, for example, to a transformer architecture. The model includes an embedding layer that maps tokens to vectors, multiple self-attention layers that compute attention weights between tokens, feed-forward layers that apply non-linear transformations such as rectified linear unit activations, and a final linear layer followed by a softmax function that outputs probability distributions over a vocabulary of tokens.

The server causes the generative information processing model to perform inference using model parameters that have been trained in advance. During an off-line training phase, a learning module updates model parameters by minimizing an error function, such as a cross-entropy loss, over a large corpus of training text. The learning module performs forward passes through the multi-layer network to compute predicted token distributions, computes gradients of the loss function with respect to the model parameters by backpropagation, and applies an optimization algorithm, such as stochastic gradient descent or an adaptive gradient method, to update the parameters. The training phase may include data augmentation techniques such as random masking of tokens, shuffling of sentence order, and synthetic perturbation of text to improve generalization. The inference-time processing reuses the trained parameters and does not change them, thereby ensuring deterministic behavior for a given input prompt sentence and decoding configuration.

The server decodes the output probability distributions from the generative information processing model to generate an answer candidate. The server applies a decoding strategy, such as greedy decoding that selects the highest probability token at each step, or a sampling-based decoding that uses a temperature parameter and a top-k or nucleus sampling criterion. The server concatenates the output tokens and converts the tokens back into character information using a decoder corresponding to the tokenizer. The result is an answer candidate expressed in a natural language.

The server applies a machine learning algorithm to evaluate the answer candidate. The server can implement the machine learning algorithm as a separate classifier or ranking model. In one example, the server represents the question and the answer candidate as feature vectors using an encoder network, such as a bidirectional transformer encoder, that outputs contextual embeddings. The server concatenates or combines the embeddings and inputs the combined vector into a classification layer that outputs a score representing relevance, coherence, or policy-alignment. The server trains this evaluation model on labeled pairs of questions and answers, using an error function such as binary cross-entropy or mean squared error, and updates weights by backpropagation in a training phase distinct from the generative model training.

The server stores evaluation information corresponding to the answer candidate, such as a numeric score, a confidence label, or a rank relative to alternative answer candidates. The server uses this evaluation information to control an output format of the answer candidate. For example, the server may suppress overly long answers when the evaluation information indicates low confidence, or the server may augment the answer candidate with additional clarifications when the evaluation information indicates borderline suitability. The server may also alter section headings, add structured bullet lists, or attach references to internal resources based on rule sets that are keyed by thresholds of the evaluation information.

The server generates response data including at least the answer candidate, identification information indicating that the answer candidate is generated by the generative information processing model, and the evaluation information. The server structures the response data in a data object and converts the data object into a representation appropriate for network transmission. The server then transmits the response data to the terminal via the communication network.

The terminal receives the response data and reconstructs the data object. The terminal extracts the answer candidate, the identification information, and the evaluation information. The terminal updates a graphical user interface that includes a conversation view, and displays the answer candidate as a message element. The terminal outputs the identification information, for example as a label near the answer, indicating that the content is generated by a generative AI model. The terminal also displays the evaluation information, such as a score bar or a textual confidence indication, so that the user can judge the reliability or completeness of the answer. The terminal may adapt the font, color, or layout based on the evaluation information to highlight particularly relevant content.

The user views the answer candidate and may provide further input based on the displayed evaluation information. The user can choose to accept the answer, request a more detailed explanation, or ask a different question. When the user inputs a new question as part of the same conversation, the terminal includes identifiers that allow the server to retrieve corresponding history information. The server then constructs a new prompt sentence that incorporates prior questions and answer candidates, allowing the generative information processing model to generate context-aware answers.

The system improves computer technology by optimizing data structures and processing flows between the terminal, the server, and the generative information processing model. The server maintains structured history information and uses this information directly in the prompt sentence, reducing the need for the user to re-enter context manually and thereby decreasing redundant model invocations. Because the server constructs context-rich prompt sentences and evaluates answer candidates using a machine learning model, the system can increase the probability that an answer candidate satisfies the user's informational need in a single exchange. This yields a reduction in overall network traffic and processing load, as fewer back-and-forth communications and fewer repeated inferences are required.

The server also improves computational efficiency by separating generative modeling and evaluation modeling. The generative information processing model is optimized for sequence prediction, while the evaluation model is optimized for scoring. The server thereby avoids using the generative model for tasks for which it is not well adapted, and instead uses a specialized model with a simpler architecture and lower computational cost to evaluate answer candidates. This separation reduces average inference time and energy consumption on the server hardware.

The use of structured prompt sentences that explicitly include message sequences and instruction text also improves the internal behavior of the generative information processing model. The model receives inputs that consistently encode conversational context and user role information, which reduces variance in generated answers and increases stability. By controlling the prompt structure and decoding parameters at the server, the system achieves a technical effect of predictable and reproducible output patterns, enabling easier monitoring, logging, and feedback-based optimization.

The server uses non-conventional rules to select history messages and to format prompt sentences. For instance, the server can apply a sliding-window algorithm that selects a subset of message sequences based on both recency and semantic similarity computed via vector embeddings. The server may compute similarity scores using cosine similarity between embedding vectors of past questions and the current question, and then select messages whose similarity exceeds a threshold while still respecting a maximum token budget. This rule-based selection is different from simple chronological truncation and yields a more efficient use of the generative model's input window, enhancing answer quality without increasing computational cost.

In some embodiments, the generative information processing model and the evaluation model are deployed on different physical hardware units. The server may route prompt sentences to a high-performance accelerator device that executes the generative model, while the evaluation model operates on a central processing unit with vector instruction support. This hardware-aware distribution allows the system to balance load and prevents bottlenecks, resulting in improved throughput and reduced latency for concurrent sessions.

The server, in certain configurations, further compresses communication data and response data prior to transmission. The server may apply text compression algorithms, such as dictionary-based compression, to the structured data objects while ensuring that the terminal can decompress them using a complementary algorithm. This reduces bandwidth usage on the communication network and lowers transmission time, especially over wireless links. The terminal and the server cooperate to maintain security and integrity of the data. The terminal encrypts communication data at the transport layer, and the server decrypts the data before processing. The server verifies integrity by checking message authentication information. These mechanisms ensure that the question and the answer candidate remain consistent and untampered, allowing the machine learning models to operate on valid data and preventing the degradation of evaluation accuracy due to corrupted inputs.

Alternative embodiments can vary the internal architecture of the generative information processing model. For example, the model may include encoder-decoder components, recurrent units, or convolutional layers, provided that the model receives a prompt sentence and outputs an answer candidate as a sequence of tokens. The evaluation model may also vary, such as using gradient-boosted decision trees on hand-crafted features extracted from the question and the answer candidate. The machine learning algorithm may employ different loss functions, such as hinge loss or ranking loss, depending on whether the system is configured to produce absolute quality scores or pairwise preference rankings. Alternative embodiments can also vary the structure of the prompt sentence. In some cases, the server formats the prompt with explicit speaker tags and delimiters. In other cases, the server uses a narrative style in which history information is summarized into a short paragraph preceding the current question. The prompt sentence may include control tokens that explicitly specify language, tone, or answer length, and the generative information processing model may be trained to interpret such control tokens.

Through these configurations, the server, the terminal, and the user form a system that is not limited to abstract data manipulation but implements a concrete improvement in computer-based question answering. The system modifies how data is structured, how models are invoked, how outputs are evaluated, and how responses are formatted and transmitted. These modifications yield measurable technical effects, including increased response accuracy for a fixed computational budget, reduced network usage through fewer iterative queries, and improved utilization of model input capacity through context-aware prompt construction.

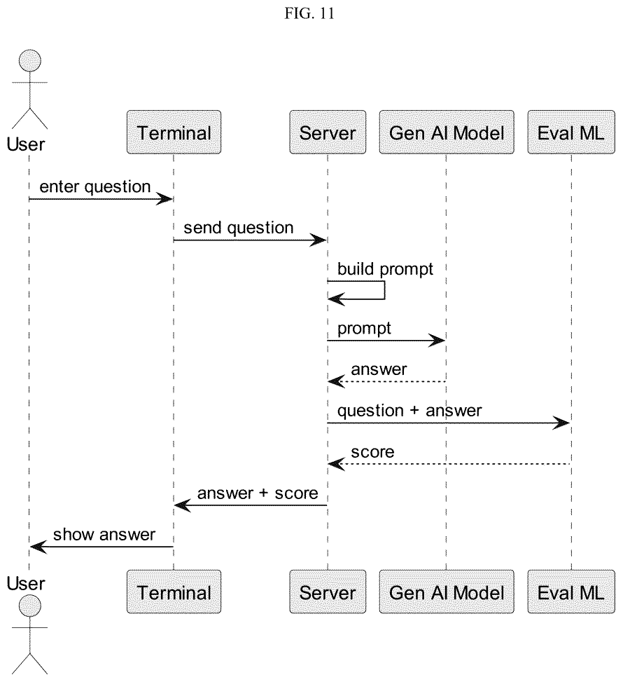

The following describes the processing flow using FIG. 11.

### Step 1

The user inputs a question into the terminal. The user supplies, as input, natural-language text by typing on a hardware keyboard or a software keyboard displayed on a touch panel. The terminal receives this input as a raw character string and stores it in a memory buffer. The terminal outputs a normalized text string by applying basic preprocessing, such as trimming leading and trailing spaces, converting line breaks to a standard representation, and optionally converting characters to a unified encoding format such as UTF-8.

### Step 2

The terminal generates communication data including the question. The terminal uses, as input, the normalized question text and associated metadata such as a timestamp, a user identifier, and a conversation identifier stored in local memory. The terminal constructs a structured data object by assigning the question text and metadata to predefined fields, and then serializes this data object into a format suitable for transmission, such as a text-based message representation. The terminal outputs a communication data payload that encapsulates the question and metadata.

### Step 3

The terminal transmits the communication data to the server. The terminal uses, as input, the communication data payload generated in Step 2 and a destination address of the server. The terminal segments the payload into packets according to a transport protocol, attaches protocol headers, and sends the packets via a communication network interface using a network stack implementing, for example, a reliable transport protocol over an internet protocol. The terminal outputs network packets that are delivered to the server.

### Step 4

The server receives and reconstructs the communication data. The server uses, as input, the network packets transmitted by the terminal. The server reassembles the packets into the original payload, verifies integrity using checksums or message authentication information, and parses protocol headers to recover the structured data object. The server extracts the question text and metadata fields from the data object and stores them in main memory. The server outputs the normalized question text and associated metadata for further processing.

### Step 5

The server updates history information with the current interaction. The server uses, as input, the question text and metadata obtained in Step 4. The server accesses a storage device that holds previous questions and answer candidates associated with the same conversation identifier, appends the new question as a new entry in a conversation log, and optionally updates an index or key-value mapping from conversation identifiers to log entries. The server outputs updated history information that includes the newly received question.

### Step 6

The server selects message sequences for contextual prompting. The server uses, as input, the updated history information and the current question text. The server computes vector representations of the current question and past questions, for example using a trained encoder network that maps text to embedding vectors. The server calculates similarity scores between the current question vector and each past question vector using a similarity metric such as cosine similarity. The server then applies a selection rule that considers both recency and similarity, selecting those past question-answer pairs whose similarity exceeds a threshold while maintaining a maximum count or token budget. The server outputs a subset of message sequences consisting of selected prior questions and answer candidates.

### Step 7

The server constructs an instruction text and a prompt sentence. The server uses, as input, the current question text, the selected message sequences, and a stored instruction template that defines answer generation conditions (for example, required style, level of detail, or language constraints). The server inserts parameter values such as target language or role description into the instruction template, concatenates the instruction text with formatted representations of the selected message sequences, and appends the current question using predefined delimiters and speaker tags. The server outputs a prompt sentence as a single structured text string that encodes the instruction text, the conversation context, and the current question.

### Step 8

The server tokenizes the prompt sentence for the generative AI model. The server uses, as input, the prompt sentence produced in Step 7 and a tokenizer specification associated with the generative AI model. The server applies the tokenizer algorithm to split the prompt sentence into a sequence of tokens, for example by performing byte-pair encoding or a similar subword segmentation. The server converts each token into an integer token identifier using a vocabulary table. The server outputs an ordered sequence of token identifiers and, optionally, an attention mask sequence to be used as input to the generative AI model.

### Step 9

The server invokes the generative AI model for answer generation. The server uses, as input, the sequence of token identifiers, the attention mask, and configuration parameters such as maximum output length, temperature, and sampling options. The server feeds the token sequence into a neural network implementing a transformer-based architecture that comprises an embedding layer, multiple attention blocks, and output projection layers. The neural network performs matrix multiplications and non-linear activations across the layers to compute, for each position, a probability distribution over the vocabulary for the next token. The server outputs probability distributions or sampled token identifiers representing the model's intermediate or final predictions.

### Step 10

The server decodes model outputs into an answer candidate. The server uses, as input, the probability distributions or sampled token identifiers generated in Step 9. When using greedy decoding, the server selects, at each time step, the token with the highest probability; when using sampling-based decoding, the server selects a token according to probabilities adjusted by temperature and top-k or nucleus criteria. The server repeats this selection until a termination condition is met, such as generation of an end-of-sequence token or reaching the maximum output length. The server then converts the resulting token sequence into character information by mapping token identifiers back to subword units and concatenating them. The server outputs the answer candidate as a complete text string in a natural language.

### Step 11

The server computes features for answer evaluation. The server uses, as input, the current question text, the generated answer candidate, and optionally the selected message sequences. The server applies an encoder network, such as a bidirectional transformer encoder, to the question and the answer candidate separately, producing embedding vectors that represent semantic content. The server may also compute additional numerical features, such as length ratios, coverage of key terms, or syntactic complexity measures. The server concatenates or otherwise combines these features into a single feature vector. The server outputs a composite feature representation that describes the relationship between the question and the answer candidate.

### Step 12

The server applies a machine learning algorithm to evaluate the answer candidate. The server uses, as input, the composite feature representation from Step 11 and trained parameters of an evaluation model, such as a feed-forward neural network or a gradient-boosted decision tree ensemble. The server propagates the feature vector through the evaluation model by performing weighted sums and activation functions, computes an output value representing a score, and may map this score to a confidence level or classification label (for example, suitable or unsuitable). The server outputs evaluation information including at least the numeric score and optionally a derived label or rank.

### Step 13

The server controls the output format of the answer candidate based on evaluation information. The server uses, as input, the answer candidate text from Step 10 and the evaluation information from Step 12. The server applies rule-based logic that compares the evaluation score to predefined thresholds; for high scores, the server may leave the answer candidate unchanged or highlight key sections, whereas for moderate scores, the server may append clarification phrases or warnings; for low scores, the server may truncate or simplify the answer or request regeneration in alternate modes. The server adjusts structural elements such as headings, bullet points, or paragraph segmentation to match configuration rules associated with the evaluation categories. The server outputs a formatted answer text that reflects these modifications.

### Step 14

The server generates response data to be transmitted to the terminal. The server uses, as input, the formatted answer text, the evaluation information, and identification information indicating that the answer is generated by the generative AI model. The server constructs a structured response object with fields for the answer text, the identification information, the evaluation score, and any auxiliary metadata. The server serializes this response object into a transferable representation and associates it with response headers required by the communication protocol. The server outputs a response data payload ready for network transmission.

### Step 15

The server transmits the response data to the terminal. The server uses, as input, the response data payload from Step 14 and addressing information associated with the terminal's communication session. The server encapsulates the payload into network packets according to the transport and network protocols, assigns sequence numbers and checksums, and sends the packets through its network interface. The server outputs outgoing network traffic that conveys the response data over the communication network to the terminal.

### Step 16

The terminal receives and decodes the response data. The terminal uses, as input, the network packets transmitted by the server. The terminal reassembles the packets, verifies integrity, and parses protocol headers to recover the serialized response object. The terminal deserializes the response data into internal data structures, extracting the formatted answer text, the identification information, and the evaluation information. The terminal outputs the decoded response elements for display processing.

### Step 17

The terminal presents the answer candidate and related information to the user. The terminal uses, as input, the formatted answer text, the identification information, and the evaluation information obtained in Step 16. The terminal updates a graphical user interface component, such as a conversation view, by inserting a new message element that contains the answer text. The terminal displays the identification information, for example as a label indicating that the content is generated by the generative AI model, and renders the evaluation information using visual cues such as numeric indicators, color coding, or icons. The terminal outputs a rendered screen image on a display device, enabling the user to visually inspect the answer and its associated evaluation.

### Step 18

The user reviews the answer and optionally initiates a follow-up interaction. The user uses, as input, the displayed answer text, the identification information, and the evaluation information. The user visually inspects the answer, considers the confidence or quality indicators, and decides whether additional clarification or a new question is needed. If the user chooses to ask a follow-up question, the user enters new text into the same interface, which the terminal captures and processes as a new input, while preserving or updating the conversation identifier in subsequent communication data. The user's action outputs a new question that restarts the processing sequence with updated context.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented training and support systems for workers in physical environments, such as retail stores or facilities, typically rely on static manuals, pre-authored FAQ lists, or simple rule-based dialog engines. These systems have several technical limitations from the perspective of computer technology. First, conventional systems generally treat user input as isolated text queries, without integrating real-time multimodal sensor data such as visual information captured by an imaging device and audio information captured by a microphone. As a result, the processing pipeline in the server cannot accurately infer the current context of the user's work situation, leading to generic responses that are not optimized for the user's real-time environment. This causes unnecessary network traffic and computational load, because the server must generate or retrieve broad, non-specific information rather than focused guidance tailored to the detected objects in the user's field of view.

Second, even when generative AI models are employed, conventional systems do not systematically construct prompt sentences that fuse recognized speech, visual object information, and task-related information retrieved from structured data sources. Without such context-aware prompt construction, the generative AI model is forced to internally infer context from incomplete input, which increases inference variability, reduces response relevance, and requires more computational iterations or post-processing to obtain a usable answer. Consequently, system latency increases and hardware resources, such as processor cycles and memory, are consumed inefficiently.

Third, conventional server architectures do not continuously update their processing logic based on time-series multimodal data streams from user terminals. In typical systems, visual data and audio data are processed in isolation and then discarded, without being stored and exploited as temporal context. This prevents the server from learning user-specific patterns or work sequences and from dynamically adapting machine learning models or prompt generation procedures. As a result, the accuracy and relevance of answers remain static and cannot be progressively improved as the system observes more user interactions in real work environments.

Fourth, prior systems rarely optimize the final answer format for constrained display devices such as head-mounted displays or smart glasses. They generally output long, text-heavy answers without converting them into superimposed display formats suitable for limited field-of-view and short interaction windows. This mismatch between answer generation and display constraints leads to increased cognitive load on the user and requires extra manual operations such as scrolling or switching screens, thereby reducing the effectiveness of the human-computer interaction.

Accordingly, there is a need for an improved computer-implemented system and server-side processing architecture that: (i) jointly processes audio and visual input from a terminal to infer the user's current work situation; (ii) generates prompt sentences for a generative AI model in a context-aware manner based on recognized speech and task-related information derived from object recognition; (iii) stores multimodal data over time to adapt machine learning algorithms and prompt generation logic; and (iv) converts generated guidance into a superimposed display format that is technically optimized for presentation on a terminal with an integrated imaging device and display. Such improvements would enhance computational efficiency, reduce latency, and increase the technical quality and relevance of the guidance provided to users in real-time operational environments.

The specific processing by the specific processing unit 290 of the data processing device 12 in Application Example 1 is realized by the following means.

The present invention provides a server comprising a processor configured to receive audio information transmitted from a terminal that accepts a voice question from a user and execute speech recognition processing on the audio information to generate audio text information; receive visual information transmitted from the terminal, the visual information being acquired by an imaging device, execute image recognition processing on the visual information to extract object information, and acquire task-related information stored in a storage device on the basis of the object information; generate a prompt sentence to be input to a generative AI model on the basis of the audio text information and the task-related information, input the prompt sentence to the generative AI model, and cause the generative AI model to generate answer candidate information; evaluate the answer candidate information on the basis of the answer candidate information and attribute information associated with the user by using natural language processing and a machine learning algorithm, and select answer information to be presented to the user; transmit the answer information and the task-related information to the terminal and convert the answer information and the task-related information into a format displayable in superimposition on a display device of the terminal; estimate a work situation in which the user is currently engaged on the basis of the audio text information and the object information extracted from the visual information, and automatically adjust content of the prompt sentence and a representation format of the answer information in accordance with the work situation; and store, in time series, the visual information and the audio information transmitted from the terminal, and update, on the basis of stored information, the machine learning algorithm and processing for generating the prompt sentence for the generative AI model, thereby sequentially improving the answer information presented to the user. This enables integration of multimodal sensor processing, context-aware prompt sentence construction, adaptive machine learning-based answer selection, and display-optimized output formatting within a single server architecture, thereby improving computational efficiency, reducing response latency, and enhancing the technical relevance and usability of real-time guidance provided to users in physical work environments.

The term “system” refers to an arrangement of one or more hardware devices and software components that cooperate to execute the processing defined in the claims.

The term “server” refers to an information processing apparatus including at least one processor, a memory, and communication interfaces, configured to communicate with one or more terminals over a network and to execute the functions defined in the claims.

The term “processor” refers to a hardware computation unit, such as a central processing unit or a dedicated processing circuit, capable of executing instructions to perform operations including speech recognition processing, image recognition processing, natural language processing, and machine learning processing.

The term “terminal” refers to a user-operated information device including at least an imaging device, a microphone, a display device, and a communication interface, and configured to transmit audio information and visual information to the server and to present information received from the server to the user.

The term “user” refers to a human operator who interacts with the terminal by providing voice input and receiving displayed output during performance of tasks in a real or virtual environment.

The term “audio information” refers to digital data representing a sound signal acquired from the user or surrounding environment by a sound capturing device, such as a microphone, and transmitted from the terminal to the server.

The term “voice question” refers to a spoken utterance provided by the user, expressing an inquiry or request for guidance, and captured as audio information by the terminal.

The term “speech recognition processing” refers to a computational procedure that converts audio information containing speech into corresponding text data by analyzing acoustic features and linguistic patterns.

The term “audio text information” refers to text data generated by speech recognition processing from audio information that includes a voice question uttered by the user.

The term “visual information” refers to digital data representing an image or video frame captured by an imaging device of the terminal and transmitted to the server.

The term “imaging device” refers to an optical sensor unit, such as a digital camera or image sensor, configured to capture visual information of a scene in front of the terminal.

The term “image recognition processing” refers to a computational procedure that analyzes visual information to detect, classify, or localize objects or regions of interest and to output symbolic or numeric representations of such objects or regions.

The term “object information” refers to data indicating the presence, category, position, or identifier of one or more objects detected within the visual information as a result of image recognition processing.

The term “storage device” refers to a hardware component, such as a memory device or a non-volatile storage unit, configured to store data including task-related information, attribute information, and time-series multimodal information.

The term “task-related information” refers to data stored in the storage device that describes procedures, rules, policies, or other operational knowledge relevant to tasks associated with the object information extracted from visual information.

The term “prompt sentence” refers to a text expression generated by the processor, which combines context information including audio text information and task-related information, and is supplied as input to a generative AI model to cause generation of answer candidate information.

The term “generative AI model” refers to a software-implemented inference model employing machine learning techniques to generate natural language text or other output content in response to a given prompt sentence.

The term “answer candidate information” refers to one or more pieces of response data produced by the generative AI model when the prompt sentence is input, prior to selection of final answer information to be presented to the user.

The term “attribute information” refers to data associated with the user, such as role, experience level, language preference, or task assignment, used by the processor when evaluating answer candidate information.

The term “natural language processing” refers to a set of computational techniques for analyzing, interpreting, or transforming text data, including operations such as tokenization, semantic analysis, and similarity evaluation.

The term “machine learning algorithm” refers to a computational method that learns patterns or decision rules from data and is used by the processor to evaluate answer candidate information and to select or improve answer information.

The term “answer information” refers to response data selected or generated by the processor, based on answer candidate information and attribute information, to be provided to the user as a final answer.

The term “display device” refers to a visual output component of the terminal, such as a head-mounted display, smart glasses display, or screen, configured to present information to the user.

The term “format displayable in superimposition” refers to a representation of information that is configured to be overlaid on a user's view or on other content on the display device, while remaining readable within the constraints of the display area.

The term “work situation” refers to a state or context of a task in which the user is currently engaged, inferred from audio text information, object information, or other contextual data.

The term “representation format of the answer information” refers to a structural or stylistic specification of how the answer information is presented, including aspects such as length, layout, bullet points, or level of detail.

The term “time series” refers to an ordered sequence of data items, such as visual information and audio information, stored together with temporal information indicating acquisition time or order.

The term “stored information” refers to accumulated time-series visual information, audio information, and related metadata that are maintained in the storage device and used to update machine learning algorithms and prompt generation processing.

In one embodiment, a server cooperates with one or more terminals to provide context-aware guidance to a user who performs tasks in a physical environment. The server includes at least one processor, a main memory, a non-volatile storage device, and a network interface. The terminal includes an imaging device, a microphone, a display device, a local processor, a local memory, and a wireless communication interface. The server and the terminal are connected through a communication network such as a wireless local network or a wide area network.

The terminal operates as a head-mounted or wearable device, such as smart glasses. The terminal captures visual information of a real-world scene through the imaging device and captures audio information of a voice question through the microphone. The terminal converts raw sensor signals into digital data using local drivers and codecs and transmits the digitized audio information and visual information to the server via a secure communication protocol.

The server stores program modules in the non-volatile storage device. The program modules include a speech recognition module, an image recognition module, a task information retrieval module, a prompt sentence generation module, a generative AI interaction module, an answer evaluation module, a display formatting module, a work situation estimation module, and a learning and update module. The processor loads these modules into main memory and executes them to implement the claimed functions.

The server uses a speech recognition module to transform audio information into audio text information. In one embodiment, the server calls an external speech recognition service via an application programming interface. The server encodes the audio information in a linear pulse-code modulation format with a defined sampling frequency and bit depth, and transmits the encoded stream together with metadata specifying the language code and acoustic parameters. The speech recognition service performs acoustic modeling and language modeling and returns a string that represents the recognized text. The server receives this string as the audio text information and stores it in a structured record together with a timestamp and an identifier of the associated visual information.

The server uses an image recognition module to process visual information. The server decodes compressed image data into a numerical array and normalizes pixel values. In one embodiment, the server employs an object detection neural network, such as a convolutional neural network that includes convolution layers, pooling layers, and fully connected layers.

The server inputs the normalized visual information to this neural network to obtain object information comprising object categories, bounding box coordinates, and confidence scores.

The server discards detections with confidence scores below a threshold and selects one or more objects that are spatially prominent or relevant to a predefined region of interest. The server associates each selected object with an object identifier stored in a mapping table within the storage device. The server uses the task information retrieval module to access task-related information. The server maintains a structured data store, for example a relational data structure, that contains tables for procedures, policies, and descriptive entries linked to object identifiers and categories. The server forms a query based on the selected object identifiers and retrieves corresponding task-related information, such as procedure steps, safety notes, and short explanations. The server stores this task-related information in a context record associated with the current user session. The server uses the work situation estimation module to infer a work situation. The server combines the audio text information, the object information, and recent context records stored in time series in the storage device. The server represents these elements in a feature vector that includes categorical features (such as object category, user role) and temporal features (such as time since last interaction, sequence of previously detected objects). The server applies a classification algorithm, for example a gradient-boosted decision tree or a recurrent neural network, trained to output a label that represents the work situation (for example, product explanation, checkout operation, restocking operation). The server stores this work situation label together with the context record.

The server uses the prompt sentence generation module to create a prompt sentence for a generative AI model. The server constructs the prompt sentence by concatenating template segments with dynamically inserted context values. The server includes in the prompt sentence: (i) a role instruction that defines the behavior of the generative AI model, (ii) a description of the object and related task-related information, (iii) the user's audio text information, and (iv) constraints on length, tone, or output structure. The server optionally adjusts the level of detail and structure of the prompt sentence based on the work situation label and the attribute information of the user, such as experience level or preferred language.

In one concrete example, the server generates a prompt sentence in the following form:

“Context:

You are a training assistant for new store employees.

The employee is looking at the product ‘Premium Green Tea 500 ml’.

Product description: sugar-free bottled green tea, recommended for health-conscious customers.

Standard sales policy: be polite, confirm the customer's needs, and explain the product truthfully.

User question:
‘How should I explain this drink to a health-conscious customer?’
Task:

Create a short explanation (3-4 sentences) the employee can say to the customer. Mention health-related points clearly, but do not make any medical claims.” In another example, the server generates a prompt sentence in the following form:

“Context:

You are assisting a new employee in a retail store.

The product is ‘Kitchen Cleaner Spray 750 ml’, used for cleaning kitchen surfaces.

Store policy: prioritize safety, avoid exaggerated claims, and always mention wearing gloves if required.

User question:

‘How should I explain the safety precautions for this cleaner to a customer?’

Task:

List 4-5 clear bullet points that the employee can say to the customer, focusing on safe use and basic precautions. Use simple language.”

The server uses the generative AI interaction module to submit the prompt sentence to a generative AI model. In one embodiment, the generative AI model is a transformer-based neural network trained on large-scale text corpora. The neural network includes multiple attention layers, feed-forward layers, and layer normalization units. The server specifies model parameters such as a temperature parameter for controlling randomness and a maximum token limit for controlling the output length. The server sends the prompt sentence as a sequence of tokens and receives a sequence of tokens that represent answer candidate information.

The server uses an answer evaluation module to evaluate the answer candidate information. The server converts the answer candidate information into a token representation and applies natural language processing and a machine learning algorithm to assess properties such as length, relevance to the object information and work situation, and compliance with stored policies. In one embodiment, the server uses a secondary scoring model that is trained on labeled examples of suitable and unsuitable responses. This scoring model may be a smaller neural network or a gradient-boosted tree that takes as input features such as semantic similarity to the user question, inclusion of mandatory keywords, and absence of prohibited phrases. The server assigns a score to the answer candidate information and either accepts it or regenerates the answer by modifying the prompt sentence, such as tightening constraints or adding explicit instructions.

The server uses the display formatting module to transform the final answer information and associated task-related information into a format suitable for the display device of the terminal. The server enforces limits on line length and the number of visible lines, and inserts explicit line breaks or bullet markers. The server may transform sentences into numbered steps to facilitate quick reading. The server generates a markup representation that indicates overlay position, font size, and emphasis markers and transmits this representation to the terminal as part of a response message.

The terminal receives the response message and parses the markup. The terminal maps overlay coordinates to the display device and renders the answer information and task-related information as an overlaid display on top of the user's field of view. The terminal uses the local processor and graphics subsystem to draw text regions, highlight important segments, and update the display in synchronization with head movement or gaze direction, if such tracking is available. The user sees compact, context-specific guidance that requires minimal manual interaction.

The server uses the learning and update module to continuously improve processing. The server stores visual information, audio information, audio text information, object information, work situation labels, and answer evaluation scores in a time-series data structure. The server periodically uses this stored information to retrain or fine-tune machine learning algorithms. For example, the server updates parameters of the work situation estimation classifier using mini-batch gradient descent on newly collected feature-label pairs. The server also adjusts parameters of the answer evaluation model by minimizing an error function that measures divergence between human feedback labels and model scores. The server may perform data augmentation by synthetically modifying prompt sentences or by simulating noise in audio and visual features to increase robustness. By incorporating these updates, the server reduces classification errors, improves prompt sentence construction, and enhances the selection of answer information over time.

The server provides technical improvements over conventional systems in several ways. The server reduces communication load and processing overhead by using object information and work situation estimation to narrow the scope of task-related information retrieved from the storage device and to generate more precise prompt sentences. This targeted context reduces the number of tokens that must be processed by the generative AI model and shortens inference time. The server improves accuracy by integrating multimodal features (audio text information, object information, time-series context) rather than relying on a single modality. The classifier that estimates work situation operates according to rules and patterns learned from data, which differ from manual heuristics and enable finer discrimination between similar situations.

The server improves data management by storing multimodal information in a structured, time-series form with explicit links between audio information, visual information, and generated guidance. This structure enables reproducible retraining and diagnostic analysis of performance and allows the server to identify patterns such as recurring misrecognitions or frequently updated procedures. The server improves computational efficiency by separating roles among modules: the image recognition module compresses rich visual information into compact object information; the work situation estimation module further reduces dimensionality into a work situation label; and the prompt sentence generation module uses that label to condition the generative AI model. This modular pipeline reduces unnecessary processing and avoids repeated full-scene analysis for each query.

The terminal contributes to the technical effect by enabling hands-free data acquisition and display in real time. The terminal's imaging device and microphone operate under control of the local processor to capture only relevant segments of audio and visual information, such as when the user is facing a particular object or actively speaking. This selective capture reduces redundant data transmission and lowers bandwidth requirements. The terminal's display device presents information in a superimposed manner, which allows the user to maintain situational awareness while receiving guidance, thereby reducing the need for repeated interactions or corrections.

In alternative embodiments, the server may employ different neural network architectures for image recognition, such as a residual convolution network or a region-based detection network, and may use different generative AI models, such as encoder-decoder architectures trained for instruction following. The server may vary parameters such as layer depth, hidden dimension size, and attention head count. The server may train these models using supervised learning on curated datasets that contain pairs of context information and desirable outputs, using loss functions such as cross-entropy loss for classification and token-level negative log-likelihood for generation. The server updates model weights using stochastic gradient descent or variants such as Adam, with learning rate schedules and regularization terms to avoid overfitting.

In further embodiments, the server may use rule-based filters in combination with machine learning algorithms. For example, the server may enforce domain-specific rules that prohibit certain terms or require inclusion of specified warnings before finalizing answer information. The server evaluates answer candidate information against these rule sets and, if violations are detected, automatically modifies the prompt sentence to request a corrected answer. This non-conventional interaction loop between prompt sentence generation, generative AI output, and rule-based post-processing results in improved reliability, reduced manual review, and enhanced technical control over generated content.

By implementing coordinated processing across the terminal and the server, by structuring multimodal data and machine learning models in the manner described, and by explicitly optimizing prompt sentences and answer presentation for real-world devices, the system achieves technical effects beyond simple automation of human tasks. The system increases processing speed, improves guidance accuracy, decreases communication bandwidth, and enables continuous technical improvement of the underlying computer processing for multimodal, context-aware assistance in real environments.

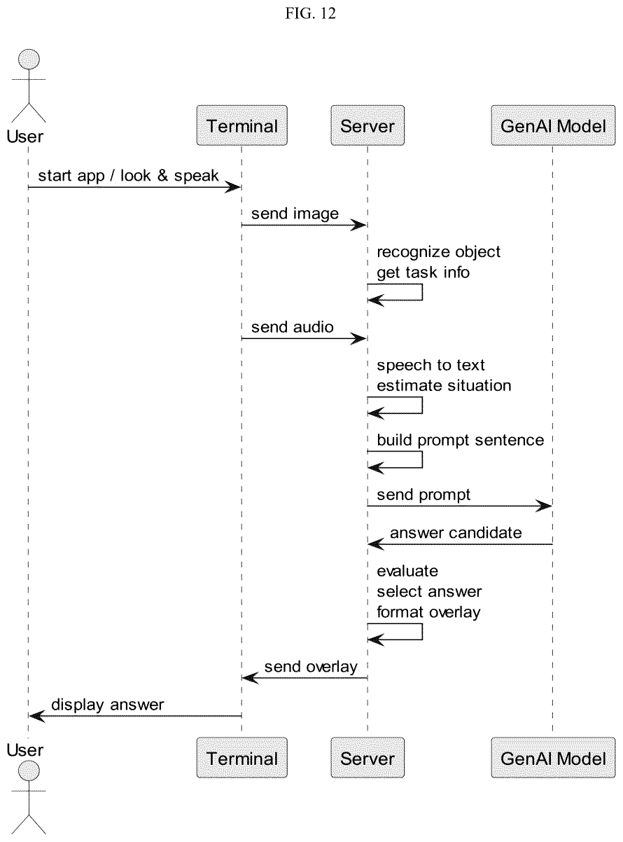

The following describes the processing flow using FIG. 12.

### Step 1

The user operates the terminal to start an application for on-site guidance.

The terminal initializes an imaging device, a microphone, a display device, and a network connection to the server.

Input: user operation (e.g., touch, button press, voice command) and device configuration data.

Output: an active session state on the terminal including session ID, initialized camera and microphone, and an established secure communication channel to the server.

The terminal uses the configuration data to allocate buffers for image frames and audio samples and to open a secure transport (for example, HTTPS) to the server, thereby preparing for continuous data transmission.

### Step 2

The terminal captures visual information from the environment through the imaging device.

The terminal periodically acquires raw image frames at a fixed frame rate and encodes each frame into a compressed image format.

Input: analog optical signals from the imaging device sensor.

Output: compressed digital image data (for example, JPEG or similar) tagged with timestamps and position or orientation metadata.

The terminal performs pixel sampling and analog-to-digital conversion, applies color space conversion and downscaling if necessary, and stores each compressed frame together with metadata in a local buffer before transmission.

### Step 3

The terminal transmits captured visual information to the server.

The terminal packs one or more compressed image frames and associated metadata into a network request and sends the request over the established secure channel.

Input: buffered compressed image data and associated metadata from Step 2.

Output: a network message containing the visual information and metadata, delivered to the server.

The terminal uses a communication library to serialize the image bytes and metadata into a structured payload and attaches a session identifier and authentication token so that the server can associate incoming data with the correct user and context.

### Step 4

The server receives the visual information and stores it for processing.

The server parses the network message, extracts the compressed image data and metadata, and registers them in a context record in storage.

Input: network message including compressed image data, timestamps, and session ID.

Output: a decoded image tensor suitable for recognition processing and a context record referencing the session and frame.

The server decompresses each image file, converts it into a numerical array (for example, height×width×color channels), normalizes pixel values to a standardized range, and stores a pointer to the array in memory along with associated session and timing information in a structured data store.

### Step 5

The server executes image recognition processing to obtain object information.

The server inputs the normalized image tensor into an image recognition model to detect objects and their positions.

Input: normalized image tensor and context record from Step 4.

Output: object information including object categories, bounding box coordinates, and confidence scores stored in the context record.

The server applies convolution operations, non-linear activation functions, and pooling operations as defined by the network architecture, computes feature maps, and applies a detection head that outputs candidate bounding boxes and labels, then filters these candidates based on a confidence threshold and non-maximum suppression to produce final object information.

### Step 6

The server maps object information to identifiers and retrieves task-related information.

The server uses detected object categories or visual markers (for example, codes or labels) to look up object identifiers and associated procedures from a structured storage device.

Input: object information from Step 5 and a data structure (for example, mapping table or database) stored in the storage device.

Output: task-related information such as procedure steps, descriptions, and policy items linked to the current object.

The server executes one or more queries to the data structure, uses the object category and, when available, a decoded identifier to retrieve records, performs joins or merges between procedure and policy tables, and assembles a consistent task-related information object for the current context.

### Step 7

The terminal captures a voice question from the user using the microphone.

The user articulates a question related to the current task or object, and the terminal records the spoken audio over a time window.

Input: acoustic signals generated by the user and received by the microphone.

Output: digitized audio data (for example, a sequence of PCM samples) stored in a buffer on the terminal.

The terminal applies analog-to-digital conversion, frames the audio stream into fixed-size buffers, may perform basic noise suppression, and stores the recorded voice question until transmission is initiated.

### Step 8

The terminal transmits audio information representing the voice question to the server.

The terminal encapsulates the digitized audio data along with session ID and any available context identifiers and sends this package to the server.

Input: buffered digitized audio samples and session/context metadata from Step 7.

Output: a network message containing audio information that arrives at the server. The terminal may compress the audio using a selectable codec or send it in raw form, attaches headers indicating sampling rate and encoding type, and transmits the message using the secure communication channel to minimize latency and maintain integrity.

### Step 9

The server performs speech recognition processing to generate audio text information.

The server passes the audio information to a speech recognition module, which converts the audio waveform into a textual representation.

Input: digitized audio data and audio format parameters from Step 8.

Output: audio text information consisting of a string that transcribes the user's voice question.

The server segments the audio into frames, extracts acoustic features (for example, Mel-frequency cepstral coefficients), feeds the features into an acoustic model and a language model, obtains probable symbol sequences, and applies decoding algorithms such as beam search to select the most likely text output.

### Step 10

The server estimates a work situation based on multimodal context.

The server combines recent object information, task-related information, and current audio text information to infer a label representing the user's current work situation.

Input: audio text information from Step 9, object information from Step 5, and stored context history.

Output: a work situation label and associated confidence score stored in the context record.

The server converts the inputs into a joint feature vector, applies a learned classifier (for example, a recurrent or tree-based model) that computes class probabilities for possible situations, selects the label with maximum probability that exceeds a threshold, and records this label for use in subsequent processing.

### Step 11

The server generates a prompt sentence for a generative AI model.

The server constructs a text prompt that includes instructions for behavior, descriptions of the object and task-related information, the user's question, and constraints tailored to the estimated work situation and user attributes.

Input: audio text information from Step 9, task-related information from Step 6, work situation label from Step 10, and attribute information associated with the user.

Output: a structured prompt sentence as a single text string ready to be input to a generative AI model.

The server selects a template based on the work situation, inserts specific object names, procedure summaries, and policy elements, appends the user's question verbatim, and adds explicit instructions regarding response length, structure, and tone, thereby forming a coherent prompt sentence.

### Step 12

The server transmits the prompt sentence to a generative AI model and obtains answer candidate information.

The server tokenizes the prompt sentence and invokes an inference interface of the generative AI model to generate a response.

Input: prompt sentence from Step 11 and model configuration parameters (such as temperature and maximum token count).

Output: answer candidate information represented as generated text corresponding to a proposed answer.

The server converts the prompt into a sequence of discrete tokens, feeds the tokens through layers of the generative AI model (including attention and feed-forward layers), collects the output token probabilities at each step, samples or selects tokens to form the response, and converts the generated tokens back into text.

### Step 13

The server evaluates the answer candidate information and selects answer information.

The server analyzes the generated text using natural language processing and a machine learning algorithm to determine suitability with respect to relevance, content constraints, and user attributes.

Input: answer candidate information from Step 12, user attribute information, task-related information, and stored policy data.

Output: finalized answer information that meets predefined criteria for presentation to the user.

The server extracts features from the generated text, such as semantic similarity scores relative to the user's question, keyword coverage, and presence of disallowed terms, feeds these features to a scoring model or rule set, computes an evaluation score, and either accepts and possibly truncate or reformat the text, or triggers regeneration with an adjusted prompt if the score is below a threshold.

### Step 14

The server formats the answer information and task-related information for superimposed display.

The server converts the textual content into a layout suitable for the terminal's display, including line breaks, bullet markers, and position hints.

Input: answer information from Step 13, associated task-related information from Step 6, and display capability data of the terminal.

Output: a formatted display description specifying textual content and its overlay layout parameters.

The server measures text length, segments long content into shorter lines, chooses a representation style (for example, numbered steps), assigns relative positions by generating coordinates or layout tags, and encapsulates the layout and content in a structured message for the terminal.

### Step 15

The server transmits the formatted display description to the terminal.

The server sends the overlay specification and text content over the network using the existing session channel.

Input: formatted display description from Step 14 and terminal session identifier.

Output: a network message containing overlay instructions and text delivered to the terminal.

The server attaches session and message identifiers, serializes the description into a transport format, and ensures delivery confirmation so that the terminal can synchronize the displayed content with the current context.

### Step 16

The terminal renders the answer information and task-related information on the display device.

The terminal parses the received overlay instructions and uses its graphics subsystem to draw the content over the user's field of view.

Input: network message received from the server in Step 15.

Output: visual output on the display device that superimposes answer information and task-related information on the real-world scene.

The terminal maps the overlay layout parameters to display coordinates, selects fonts and sizes according to local settings, draws the text and any highlight indicators, and refreshes the display so that the user sees the guidance without losing view of the physical environment.

### Step 17

The server logs multimodal interaction data for learning and improvement.

The server records visual information, audio information, audio text information, object information, work situation labels, and evaluation scores in a time-series storage structure.

Input: context record elements from Steps 4, 5, 9, 10, 12, and 13.

Output: stored time-series data entries usable for model retraining and processing optimization.

The server assigns each interaction an index in temporal order, links related entries by session and object identifiers, compresses or summarizes numerical features where appropriate, and writes them to a persistent storage area designed for later analysis and learning.

### Step 18

The server updates machine learning algorithms and prompt sentence generation logic based on stored information.

The server periodically retrieves batches of stored time-series data and uses them to refine the parameters of classifiers, scoring models, and prompt templates.

Input: stored time-series multimodal data from Step 17.

Output: updated model parameters and revised rules or templates that influence future work situation estimation, prompt generation, and answer evaluation.

The server computes gradients of defined loss functions with respect to model parameters, applies optimization steps (for example, stochastic gradient descent or its variants), adjusts thresholds and weights in scoring functions, refines template selection rules using observed performance metrics, and commits the new configurations so that subsequent user interactions benefit from improved accuracy and efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional computer-implemented question answering systems, a server typically forwards a user's natural-language question directly, or after only simple keyword extraction, to a generative AI model. In such systems, a prompt passed to the generative AI model is often constructed in a static or ad hoc manner and does not adequately encode the user's intent, topic, or contextual attributes. As a result, the generative AI model may generate answers that are verbose, unfocused, or misaligned with the user's actual information need, thereby reducing the effectiveness of the system.

Furthermore, many existing systems treat the generative AI model as a black box and do not systematically collect and exploit user feedback data in connection with the original question, the prompt content, and the generated answer. Without persistent association of these elements and adaptive adjustment of prompt-generation logic or model operation parameters, the system cannot effectively learn from past interactions. This leads to a technical limitation in that the quality and consistency of generated answers do not improve over time, even when large amounts of interaction data are available.

Additionally, traditional architectures do not provide a structured pipeline that includes normalization and structured analysis of the user question, template-based dynamic prompt construction, multiple prompt variants for the same structured information, and machine-learning-based selection among multiple answer candidates. The absence of such an integrated pipeline causes inefficiencies in computation and degrades the ability of the server to efficiently utilize processing resources when interacting with a generative AI model. For example, suboptimal prompts may trigger unnecessary model computation or require repeated queries, thereby increasing latency and resource consumption.

Accordingly, there is a need for a computer-implemented system and method that improves the technical functioning of a question answering server by (i) transforming unstructured natural-language questions into structured information including intent and important terms, (ii) dynamically generating prompt sentences using templates selected according to intent and topic classifications, (iii) interacting with a generative AI model using one or more optimized prompt sentences, and (iv) exploiting user feedback and past evaluation information to automatically refine the prompt-generation logic and model operation parameters. By improving these internal data processing and control mechanisms, the server can more efficiently orchestrate interactions with the generative AI model, reduce unnecessary computation, and improve the accuracy, relevance, and stability of generated answers in a way that constitutes a concrete improvement in computer technology.

The specific processing by the specific processing unit 290 of the data processing device 12 in Example 2 is realized by the following means.

The present invention provides a server comprising a processor and a communication interface, the processor being configured to receive, via the communication interface, a natural-language question input by a user through a terminal device, perform character-string normalization and natural-language processing on the question to generate structured information including at least an intent classification result, a topic classification result, and important terms, select a prompt template according to at least one of the intent classification result and the topic classification result, generate a prompt sentence by embedding the structured information and at least a part of an original wording of the question into the selected prompt template, transmit the generated prompt sentence to a generative AI model via the communication interface, obtain from the generative AI model at least one answer candidate generated based on the prompt sentence, perform post-processing on the at least one answer candidate to create answer data in a format suitable for presentation on the terminal device, transmit the answer data to the terminal device for display to the user, store, in association, the question, the prompt sentence, the answer data, and evaluation information or feedback information received from the user, and execute a machine-learning algorithm to update at least one of a prompt-generation logic and an operation parameter for interaction with the generative AI model based on the stored association, so that subsequent prompt sentences and answer candidates are adaptively optimized. This enables the server to internally transform unstructured user questions into structured representations, to dynamically construct and refine prompt sentences tailored to user intent and topic, to efficiently drive the generative AI model with improved prompts, and to iteratively enhance answer quality and system performance over time through feedback-driven machine learning, thereby providing a concrete technical improvement in the operation of computer-based question answering systems.

The term “processor” refers to a hardware-based data processing unit, such as a central processing unit or a processing circuit, that executes instructions to perform operations including receiving input data, analyzing text, generating control signals, and communicating with external components.

The term “terminal” refers to an electronic device operated by a user, such as a portable information processing device or a stationary information processing device, that provides an input interface for entering a question and an output interface for displaying answer data.

The term “natural-language question” refers to a sequence of characters or tokens expressed in a human language, input by a user without requiring a predefined command format, and representing an information request or inquiry.

The term “character-string normalization processing” refers to processing that converts an input text into a normalized representation, including at least one of converting character types, unifying encoding formats, standardizing whitespace, and adjusting letter case, in order to reduce variation in textual data.

The term “natural-language processing” refers to computational processing applied to natural-language text, including at least one of tokenization, morphological analysis, part-of-speech tagging, syntactic analysis, semantic analysis, and intent classification, to extract structured information from unstructured text.

The term “structured information” refers to data that represents analyzed content of a natural-language question in a machine-interpretable form, including at least one of an intent classification result, a topic classification result, and important terms.

The term “intent classification result” refers to a classification label or category indicating a type of user objective or purpose inferred from a natural-language question, such as a request to obtain a procedure explanation or a request to confirm a policy.

The term “topic classification result” refers to a classification label or category indicating a subject matter of a natural-language question, such as an expense-related topic or a work-condition-related topic.

The term “important terms” refers to words, phrases, or tokens extracted from a natural-language question that have high relevance to the intent or topic of the question and are used to guide subsequent processing, including prompt generation and answer generation.

The term “prompt template” refers to a predefined textual or structural pattern including variable fields into which structured information is embedded, the prompt template being used as a base form to generate a prompt sentence for a generative AI model.

The term “prompt sentence” refers to a text string constructed for input to a generative AI model, the text string including at least one of the original wording of a user question, an intent indication, a topic indication, and important terms, and serving as an instruction to guide answer generation.

The term “generative AI model” refers to a machine-learned model, such as a neural network model or a transformer-based language model, that generates natural-language text or other output data based on an input prompt sentence.

The term “communication interface” refers to a hardware and software combination that enables data exchange between the server and external devices or services, including at least one of a network interface, a communication protocol stack, and an application programming interface.

The term “answer candidate” refers to a piece of text or data generated by the generative AI model in response to a prompt sentence, the answer candidate being subject to post-processing and selection before being presented to a user.

The term “post-processing” refers to processing applied to an answer candidate after generation by the generative AI model, including at least one of formatting processing, information-structuring processing, and length-control processing, to transform the answer candidate into answer data suitable for presentation.

The term “formatting processing” refers to processing that adjusts the visual or structural layout of text, including at least one of inserting headings, bullet points, numbering, or line breaks, such that the content is more readable on a user interface.

The term “information-structuring processing” refers to processing that organizes content of an answer candidate into logical sections or categories, including at least one of separating steps, grouping related information, and labeling subsections.

The term “length-control processing” refers to processing that adjusts a length of an answer candidate, including at least one of truncating, summarizing, or expanding content, in order to conform to predetermined constraints or usability requirements.

The term “answer data” refers to data generated after post-processing of at least one answer candidate, the data having a format and structure suitable for presentation on a terminal as a response to a user question.

The term “evaluation information” refers to data indicating a quality assessment or usefulness assessment of answer data by a user, including at least one of rating values, selection of evaluation options, and explicit comments.

The term “feedback information” refers to additional information provided by a user regarding answer data, including at least one of corrections, suggestions, requests for clarification, and indications of missing content.

The term “prompt-generation logic” refers to processing rules, models, or algorithms implemented by the processor to determine how structured information and user context are mapped to a prompt template and how a prompt sentence is constructed.

The term “operation parameter” refers to a configurable value that influences behavior of an interaction with a generative AI model, including at least one of a model selection parameter, a temperature parameter, a maximum output length parameter, and a prompt-structure parameter.

The term “machine-learning algorithm” refers to a computational method that adjusts internal parameters of a model or logic based on training data, including at least one of supervised learning, reinforcement learning, or online learning, to improve performance of prompt generation or answer selection.

The term “user attribute” refers to information associated with a user, including at least one of a role, a department, a language preference, an experience level, and a past interaction history, which can be used to customize prompt sentences or evaluate answer candidates.

In one embodiment, a server, a terminal, and a user cooperate to implement the invention. The server includes at least one processor, a memory, a non-transitory storage device, and a communication interface connected to a data network. The terminal includes at least one processor, a memory, a display, an input device such as a touch panel or keyboard, and a communication interface. The user operates the terminal to input natural-language questions and to view answer data returned from the server. T

he server executes a program stored in the non-transitory storage device and loaded into the memory. The program is implemented, for example, as an application executed on a general-purpose computing platform. The server uses an operating system such as a server-class operating system, a web server component such as a general-purpose HTTP server, and an application framework such as a web-application framework. The server further uses a natural-language processing library such as a tokenization and part-of-speech tagging library or a morphological analyzer, and a machine-learning framework such as a neural-network framework to perform classification and reinforcement learning. The server is connected, via the communication interface and a network protocol such as HTTPS over TCP/IP, to a generative AI model that may be hosted on a separate inference server or external AI service.

The server stores in the storage device a set of data structures that are specifically designed to support the claimed operations. The server stores a prompt-template database in which each record includes at least a template identifier, an intent-classification label, a topic-classification label, and a template string that contains placeholders for structured information fields such as intent, topic, user attributes, and important terms. The server stores a user-profile database in which each record includes at least a user identifier, role information, language preferences, historical interaction features, and aggregated feedback statistics. The server stores a question-log database in which each record includes at least a question identifier, the original natural-language question text, a normalized version of the question, structured information (intent classification result, topic classification result, important terms), one or more prompt sentences generated for that question, one or more answer candidates generated in response, and feedback or evaluation information supplied by the user.

The server uses the processor to perform character-string normalization processing on the natural-language question text. The server applies, for example, Unicode normalization, whitespace compaction, conversion between character variants, and case normalization according to a language-detection result. The server uses a natural-language processing library executed by the processor to perform tokenization, morphological analysis, part-of-speech tagging, and dependency parsing. The server converts output of such analysis into a structured representation, such as an internal object or record that includes an array of tokens, parts of speech, and dependency relations. Based on this representation, the server executes an intent-classification model and a topic-classification model.

The server implements the intent-classification model and the topic-classification model as machine-learned models, for example as feedforward neural networks or transformer-based classifiers that operate on tokenized text embeddings. The server uses a machine-learning framework to represent these models as parameterized functions with weight parameters stored in the storage device. The server loads the weight parameters into memory at runtime and applies the models to the tokenized question. The server uses pre-trained word-embedding or subword-embedding representations, such as vectors of fixed dimension, and computes, on the processor, matrix multiplications and non-linear activation functions to obtain class probability distributions. The server then selects intent and topic labels corresponding to maximum probabilities. Because these classifiers operate on structured representations and embeddings, they enable the server to consistently categorize questions in a way that is reproducible and efficient in computational terms, reducing the need for ad hoc rule-based parsing.

The server further extracts important terms from the normalized and analyzed question text.

The server uses a combination of rule-based keyword extraction and statistical weighting such as term-frequency based scoring or attention-weight extraction from the intent-classification model. The server stores the extracted important terms as a list or set in the structured information. In addition, the server associates user attributes retrieved from the user-profile database with the structured information, so that the prompt generation and answer evaluation can be customized. The server uses the structured information, including the intent-classification result, topic-classification result, important terms, and user attributes, as input to a prompt-generation module. The server retrieves, from the prompt-template database, a prompt template whose intent label and topic label match the classification results. The prompt template is represented as a text pattern with placeholders, such as “You are an onboarding assistant for our organization. The user is asking about [TOPIC]. Please provide a detailed explanation suitable for [USER_ROLE] including [INFORMATION_ITEMS]. The user asked: ‘[ORIGINAL_QUESTION]’.” The server replaces the placeholders with values derived from the structured information and user profile.

For example, when the user asks “What is the procedure for expense reimbursement?”, the server generates a prompt sentence such as:
“You are an onboarding assistant for our organization. The user is a new employee asking about expense reimbursement. Please explain in detail the procedure for expense reimbursement, including who is eligible, what expenses are covered, which system should be used, how to submit a claim, the approval flow, and typical processing times. The user asked: ‘What is the procedure for expense reimbursement?’ Provide the answer in clear, numbered steps.”

When the user asks “am I allowed to work remotely three days a week?”, the server generates a prompt sentence such as:
“You are an HR policy assistant. The user is asking about remote work rules. Please explain whether working remotely three days per week is generally allowed, and describe any conditions, approval requirements, and exceptions. The user asked: ‘Am I allowed to work remotely three days a week?’ Provide the answer in a concise, easy-to-understand format.”

The server uses the communication interface to transmit the generated prompt sentence to a generative AI model endpoint. The generative AI model is implemented, for example, as a transformer-based neural network with multiple encoder-decoder or decoder-only layers, self-attention mechanisms, and feedforward sublayers. The generative AI model includes a vocabulary embedding matrix, positional encoding, multiple attention heads, and an output projection layer that maps hidden states to token probabilities. The model is trained in advance on large-scale text corpora using a language-modeling objective that minimizes a loss function such as cross-entropy between predicted token distributions and ground-truth tokens. During training, the generative AI model updates weight parameters using an optimization algorithm such as stochastic gradient descent or an adaptive gradient method, computing gradients by backpropagation across the transformer layers.

The server interacts with the generative AI model in inference mode. The server tokenizes the prompt sentence and supplies token identifiers and, in some embodiments, control parameters such as a temperature parameter and a maximum token length parameter to the generative AI model. The server executes a sequence of network requests, each containing the prompt information, and receives from the generative AI model a sequence of tokens that are decoded into an answer candidate string. The generative AI model performs, on dedicated hardware accelerators such as graphics processing units or tensor processing units, matrix multiplications and attention computations, thereby reducing inference latency and enabling high-throughput generation.

The server may generate multiple prompt sentences for the same structured information by varying prompt templates or by adding different instructions. For example, the server may generate a first prompt sentence emphasizing step-by-step instructions, and a second prompt sentence emphasizing policy summaries. The server sends each prompt sentence separately to the generative AI model and receives corresponding answer candidates. By generating different prompts in this structured way, the server can explore alternative answer formulations without re-analyzing the original question, leading to improved answer diversity with minimal additional processing.

The server performs post-processing on each answer candidate. The server parses the answer candidate text and applies formatting processing such as inserting explicit “Step 1,” “Step 2,” and so on, creating bullet lists, grouping related items into sections, and enforcing heading styles. The server performs information-structuring processing by splitting the answer into logical segments, such as “Eligibility,” “Required Documents,” “Submission Steps,” and “Approval Flow,” according to either rule-based patterns or segment-classification models. The server executes length-control processing by applying truncation or summarization algorithms if the answer exceeds a predefined limit, which helps to avoid overloading the terminal display and reduces network bandwidth usage.

The server then evaluates multiple answer candidates using a machine-learning algorithm that operates on feature vectors derived from the question, the prompt sentences, the answer candidates, and the user attributes. The server may use, for example, a gradient-boosted decision tree model or a small neural network that receives features such as answer length, coverage of important terms, similarity between question and answer embeddings, and historical feedback scores for similar questions. The server computes a quality score for each answer candidate and selects the candidate having the highest score as the final answer data. This evaluation step is not based on arbitrary human rules but on a learned mapping from features to quality scores, which adapts over time as more interaction data are collected.

The server stores, in the question-log database, the final answer data, the multiple answer candidates, the corresponding prompt sentences, and the evaluation scores. When the user transmits evaluation information or feedback information, such as ratings or comments, through the terminal, the server records such feedback and associates it with the stored question, prompt, and answer records. The server periodically or incrementally executes a machine-learning algorithm to update the parameters of the prompt-generation logic and the answer-evaluation model. For example, the server may employ reinforcement learning or online supervised learning to adjust weights used in template selection, prompt-structure selection, and answer scoring. The server computes gradients of a loss function that measures discrepancy between predicted quality scores and observed user feedback, and updates parameter values accordingly.

Because the server maintains explicit associations among questions, structured information, prompt sentences, answer candidates, and feedback, the server can compute aggregate statistics and feature distributions that improve model training. This data-management structure contributes to technical effects such as more stable convergence of the learning algorithm, reduction of overfitting to recent interactions, and improved long-term answer relevance. The server thus does not merely store data but organizes it into structured relationships that are specifically exploited by the training and inference procedures. The server achieves improvements in computer technology by optimizing how the generative AI model is driven and how network and compute resources are used. By converting each question into structured information and then into a carefully constructed prompt sentence, the server reduces the number of repeated interactions with the generative AI model that would otherwise be required if the model received poorly specified prompts. This leads to lower latency and reduced computational load on the inference hardware. The server's length-control and formatting operations also reduce data size transmitted to the terminal, thus lowering network traffic while maintaining usability. Furthermore, by dynamically adapting prompt-generation logic through machine learning, the server increases the precision and stability of answer generation over time, reducing the variance in output quality and decreasing the need for fall-back processing or manual corrections.

The terminal operates in cooperation with the server but does not implement complex analysis or model inference. The terminal runs a client application or browser-based interface that allows the user to input questions using an input device and to display answer data using the display. The terminal may perform simple preprocessing such as local language selection, client-side encryption, or input validation, and then transmits a formatted request to the server. The terminal receives the answer data from the server and renders the structured content, for example by mapping headings to specific font sizes, converting enumeration markers into graphical bullets or numbered lists, and allowing the user to scroll or search within the answer. By delegating computationally heavy operations to the server and using the terminal primarily as an interface device, the system allows lightweight devices to benefit from advanced generative AI capabilities without local hardware acceleration.

In another embodiment, the server may host the generative AI model locally instead of using an external AI service. In this case, the server includes a dedicated accelerator such as a graphics processing unit or a tensor processing unit, and the generative AI model weights are stored in the local storage device. The server loads the model weights into accelerator memory at startup and performs prompt inference locally. This embodiment reduces dependency on external network latency and enables the server to implement additional control logic, such as limiting maximum tokens or adjusting decoding parameters, more directly. The server can also implement data privacy policies by keeping sensitive prompts and answers within a controlled environment.

In a further embodiment, the server can support domain-specific generative AI models. The server stores separate prompt templates and tuning parameters for different application domains, such as human-resources information, technical support, or compliance guidelines. The topic-classification result determines which domain-specific model or domain-specific prompt template set is used. This architecture improves accuracy because each domain model is trained or fine-tuned on more homogeneous data. The same structured information pipeline, template selection mechanism, and feedback-driven learning algorithm are reused across domains, thereby demonstrating that the inventive architecture is not limited to a single business process but constitutes a general improvement in how computer systems manage prompt engineering and answer selection for generative AI models.

Through these embodiments, the server, the terminal, and the user cooperate in a technically specific way. The server implements a structured data flow from natural-language question to structured information, to template-based prompt sentence, to generative AI output, to post-processed answer data, and finally to feedback-driven learning updates. This structured data flow, together with the specialized data structures, machine-learning components, and hardware-accelerated generative AI inference, provides a concrete technical solution that improves processing speed, answer accuracy, computation efficiency, and resource utilization in computer-based question answering systems, beyond mere automation of human cognitive tasks.

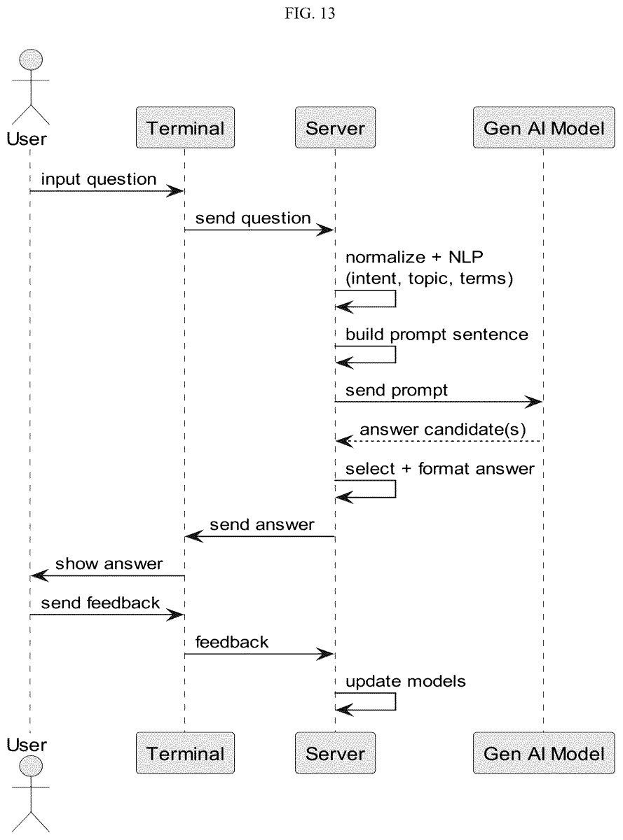

The following describes the processing flow using FIG. 13.

### Step 1

User operates the terminal to input a natural-language question using an input device such as a keyboard or touch panel. User enters, for example, the text “What is the procedure for expense reimbursement?” and confirms the input by pressing a send button. Terminal receives the confirmed question text as input from the user interface component. Terminal converts the question into an internal data structure, attaches metadata such as a user identifier and timestamp, and constructs a request message. Terminal outputs a network request containing the question text and metadata, and transmits this request to the server via a communication interface using a protocol such as HTTPS.

### Step 2

Server receives, as input, the network request containing the user's question text and metadata from the terminal through the communication interface. Server decodes the HTTP header and body, verifies basic validity of the request, and extracts the question text and associated metadata into a request object stored in memory.

Server outputs a normalized text input by applying character-string normalization processing to the extracted question text. Server performs operations including Unicode normalization, whitespace normalization, and case handling, thereby converting the raw character sequence into a standardized form that reduces representational variance before subsequent analysis.

### Step 3

Server receives, as input, the normalized question text produced in Step 2. Server uses a natural-language processing library to perform tokenization, morphological analysis, and part-of-speech tagging, generating an internal representation that includes tokens, lemmas, and grammatical tags.

Server applies an intent-classification model and a topic-classification model to this internal representation. Server computes embedding vectors for the tokens, executes matrix multiplications and non-linear activation functions in the classification models, and obtains probability distributions over intent labels and topic labels. Server selects the most probable labels and extracts important terms using rule-based filters and statistical weighting. Server outputs structured information that includes at least the intent-classification result, the topic-classification result, the list of important terms, and references to the user attributes obtained from a user-profile database.

### Step 4

Server receives, as input, the structured information and the original normalized question text. Server accesses a prompt-template database and selects a prompt template whose stored intent label and topic label match the intent-classification result and topic-classification result.

Server generates a prompt sentence by embedding elements of the structured information and the original question text into placeholder fields of the selected template. Server performs string concatenation and placeholder substitution to form a complete instruction text for a generative AI model. For example, server constructs a prompt sentence such as:
“You are an onboarding assistant for our organization. The user is a new employee asking about expense reimbursement. Please explain in detail the procedure for expense reimbursement, including who is eligible, what expenses are covered, which system should be used, how to submit a claim, the approval flow, and typical processing times. The user asked: ‘What is the procedure for expense reimbursement?’ Provide the answer in clear, numbered steps.”

Server outputs the completed prompt sentence as a text string ready to be sent to the generative AI model.

### Step 5

Server receives, as input, the prompt sentence generated in Step 4. Server prepares a model-inference request by tokenizing the prompt sentence into token identifiers, attaching generation parameters such as temperature and maximum output length, and packaging these into a request structure.

Server transmits this request through the communication interface to a generative AI model hosted either on an external service or on a local inference subsystem. Generative AI model internally processes the token sequence using a transformer architecture, performing attention computations and layer-wise transformations to predict a sequence of output tokens. Server receives, as output from the generative AI model, a sequence of tokens representing an answer candidate. Server decodes this token sequence into a natural-language answer string and stores this answer candidate in memory in association with the corresponding prompt sentence and structured information.

### Step 6

Server optionally receives, as input, multiple prompt sentences derived from the same structured information by varying prompt templates or instruction phrasing. For each prompt sentence, server repeats the operations of Step 5 to obtain a corresponding answer candidate. Server aggregates all answer candidates as input to an answer-evaluation module. Server computes feature values for each candidate, including features such as answer length, coverage of important terms, semantic similarity between the question and the candidate (calculated from embedding vectors), and predicted readability.

Server outputs a set of scored answer candidates by applying a machine-learning model that maps the feature vectors to quality scores. Server then selects the answer candidate with the highest quality score as a final answer candidate and outputs this final candidate for post-processing.

### Step 7

Server receives, as input, the selected final answer candidate text from Step 6. Server performs formatting processing by inserting headings, bullet lists, or numbered steps, using string-pattern detection and text-structure rules to segment the answer into readable units. S

erver performs information-structuring processing by grouping sentences into logical sections such as “Eligibility,” “Required Documents,” “Submission Steps,” and “Approval Flow,” based on keyword detection and learned segmentation patterns. Server applies length-control processing by truncating or summarizing portions of the answer if it exceeds a defined token or character threshold, while preserving essential information identified from important terms and section labels.

Server outputs formatted and structured answer data that is suitable for rendering on the terminal display, including metadata such as section delimiters or markup indicators.

### Step 8

Server receives, as input, the post-processed answer data from Step 7. Server packages the answer data into a response message along with identifiers for the question and user session, encodes the message into a network-transmission format such as a structured text or binary format, and adds appropriate protocol headers.

Server transmits this response message to the terminal via the communication interface. Terminal receives the response as input, parses the answer data, and maps the structure of the answer to visual components such as headings, lists, and paragraphs. Terminal renders the answer data on the display, allowing the user to scroll, read, and interact with the presented content.

Terminal outputs a user-visible representation of the answer, thereby providing the user with a detailed response to the original natural-language question.

### Step 9

User views the answer displayed on the terminal and optionally provides evaluation information or feedback information, such as selecting “helpful” or “not helpful,” assigning a rating, or entering a comment such as “Missing information about travel expenses.” User submits this evaluation or feedback through an input control on the terminal.

Terminal receives the evaluation or feedback as input, associates it with the identifier of the displayed answer, and constructs a feedback message containing the user's selections and comments. Terminal outputs this feedback message by transmitting it to the server via the communication interface.

### Step 10

Server receives, as input, the feedback message from the terminal containing evaluation information or feedback information. Server parses the message, extracts the feedback values, and associates them with the corresponding question record, prompt sentences, and answer candidates in the question-log database.

Server uses these associated data as training or update input to a machine-learning algorithm that refines the prompt-generation logic and the answer-evaluation model. Server computes gradients of a loss function that measures discrepancy between predicted quality scores and actual user feedback, updates internal weight parameters stored in the storage device, and outputs updated model parameters and revised configuration values. Server thereby improves, as output of this learning process, the internal models and rules used in future iterations of Steps 3 to 7, enabling more accurate intent classification, more effective prompt sentence construction, and more reliable answer selection in subsequent interactions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented question answering systems typically map a user's natural-language question directly to a single answer using fixed rules or a single inference model. Such systems suffer from several technical limitations. First, they lack a structured mechanism for constructing and adapting prompt sentences for a generative AI model based on rich contextual signals, such as user attributes, usage situation, and dynamically changing emotion states. As a result, the generative model is often driven by coarse or static inputs, which degrades the relevance, clarity, and tone of generated answers and leads to inefficient utilization of computational resources of the generative AI model.

Second, many existing architectures treat answer generation as a one-shot operation. They do not generate multiple answer candidates and do not apply a machine-learning-based ranking process that explicitly optimizes for objective features, such as semantic similarity, keyword coverage, readability, and predicted improvement of the user's emotional state. Consequently, they fail to exploit available computation on modern processors to systematically search for a technically superior answer within the output space of a generative AI model.

Third, emotion handling, if present at all, is typically implemented as a superficial user-interface layer and is not used as a first-class technical signal in the core answer selection pipeline. Known systems generally do not feed back emotion-derived metrics into the model selection or ranking logic and do not use emotion change data as training data to improve future inference. Hence, they cannot adapt their internal models over time to optimize system behavior for reduced user confusion or increased user satisfaction, and they do not improve their computational decision process based on historical interaction and emotion trajectories.

Fourth, conventional systems rarely implement an iterative refinement loop in which a generative AI model is re-invoked with a secondary prompt that encodes both a base answer and a detected emotion state. Without this loop, systems cannot technically adjust the tone and level of detail of an answer in a systematic, machine-controlled manner, and cannot close a feedback loop between perception (emotion recognition) and generation (answer wording) on the processor. T

herefore, there is a need for a computer-implemented question answering system that (i) programmatically constructs and updates prompt sentences for a generative AI model based on extracted linguistic features, user attributes, situational context, and emotion states; (ii) generates and ranks multiple answer candidates using a dedicated learning algorithm that considers both linguistic metrics and emotion-improvement predictions; (iii) iteratively refines a selected answer by re-prompting the generative AI model with emotion-aware instructions; and (iv) stores and reuses dialogue history and emotion change information to update the ranking algorithm and prompt generation logic. Such a system can improve the technical functioning of computer-based dialogue engines by more efficiently controlling generative models, by optimizing answer selection with respect to measurable criteria, and by adaptively improving model behavior over time based on logged interaction data.

The specific processing by the specific processing unit 290 of the data processing device 12 in Application Example 2 is realized by the following means.

The present invention provides a server comprising a processor configured to receive question information from a user, to analyze the question information by using a language processing technique to extract feature terms, to generate a prompt sentence to be input to a generative AI model on the basis of the feature terms together with user attribute information, situation information, and emotion state information, to input the prompt sentence to the generative AI model to cause the generative AI model to generate a plurality of answer candidate pieces of information, to calculate an emotion state of the user by using an emotion recognition processing module on the basis of at least one of voice information, image information, and text information of the user, to generate feature values for each of the plurality of answer candidate pieces of information on the basis of the plurality of answer candidate pieces of information, the emotion state, and past dialogue history information, to evaluate the plurality of answer candidate pieces of information by using a learning processing algorithm and to select optimal answer information, to generate modified answer information by inputting an additional prompt sentence including the optimal answer information and the emotion state to the generative AI model so as to adjust tone and detail level of the optimal answer information, to transmit the modified answer information to a terminal device and present the modified answer information to the user through a display device or an audio output device, to calculate the emotion state of the user again after the presentation and store change information of the emotion state as dialogue history information in a storage device, and to update the learning processing algorithm and processing for generating the prompt sentence on the basis of stored dialogue history information and the change information of the emotion state. This enables the server to implement a closed-loop, machine-controlled dialogue process in which prompt sentences for the generative AI model are dynamically tailored, multiple generated answer candidates are quantitatively evaluated and ranked, answer wording is iteratively refined according to detected emotions, and internal models are adaptively updated using logged interaction and emotion-change data, thereby improving the technical performance, stability, and responsiveness of the computer-based question answering system.

The term “question information” refers to data representing a user's inquiry expressed in natural language, including any associated metadata such as time, session identifier, or context that is used for processing the inquiry.

The term “user attribute information” refers to data describing characteristics of a user, such as role, experience level, affiliation, or preference profile, which are used to control how an answer is generated or presented.

The term “situation information” refers to data representing a usage context in which a question is made, such as a usage location, device condition, service scenario, or environmental state relevant to answering the question.

The term “emotion state information” refers to data representing an estimated emotional condition of a user, including one or more emotion categories and associated intensity values derived from user input.

The term “language processing technique” refers to a computational method by which a processor analyzes natural language data, including operations such as tokenization, part-of-speech tagging, syntactic parsing, lemmatization, and keyword or entity extraction.

The term “feature terms” refers to words, phrases, or other linguistic units extracted from question information that are determined to be important for understanding the intent or content of the question.

The term “prompt sentence” refers to an instruction sentence supplied as input to a generative AI model, the instruction sentence specifying constraints, style, content, or behavior for generating an answer.

The term “generative AI model” refers to a trained information processing model that receives input including a prompt sentence and outputs generated content, such as natural language text, by computing conditional probability distributions over possible outputs.

The term “answer candidate pieces of information” refers to multiple alternative answer texts or structures generated by a generative AI model in response to a prompt sentence, each alternative being a potential answer to a user's question.

The term “emotion recognition processing module” refers to a hardware or software component configured to estimate a user's emotion state from at least one type of user signal, including voice information, image information, or text information.

The term “voice information” refers to audio data representing speech produced by a user, including raw samples, encoded signals, or derived acoustic features.

The term “image information” refers to visual data associated with a user, including still images or video frames capturing a user's face or body, from which emotional cues can be inferred.

The term “text information” refers to character string data representing content input or output in textual form, such as a typed question, a transcript of speech, or a generated answer.

The term “learning processing algorithm” refers to a machine learning algorithm that receives feature values as input and computes evaluation values or selection outputs by applying a model trained on historical data.

The term “feature values” refers to numerical or categorical quantities computed from answer candidate pieces of information, emotion state information, or dialogue history information, and used as inputs to a learning processing algorithm.

The term “past dialogue history information” refers to recorded data describing previous interactions between the system and one or more users, including questions, answers, emotion states, timestamps, and any evaluation results.

The term “optimal answer information” refers to an answer candidate piece of information selected by a learning processing algorithm as best satisfying predetermined criteria, such as relevance, clarity, and predicted improvement of a user's emotion state.

The term “modified answer information” refers to answer information obtained by refining an optimal answer information using additional processing, including adjustment of tone, style, level of detail, or structure in accordance with emotion state information.

The term “terminal device” refers to an information processing apparatus operated by or near a user, such as a portable device, head-mounted display, or computing terminal, that transmits question information and presents answer information.

The term “display device” refers to a visual output component configured to present information to a user, such as a screen, projection unit, or head-mounted display element.

The term “audio output device” refers to an output component configured to present sound to a user, such as a speaker or an earphone, which can reproduce synthesized or recorded audio corresponding to answer information.

The term “storage device” refers to a memory subsystem, such as a volatile memory, non-volatile memory, or external storage medium, that retains dialogue history information, emotion state information, or model parameter data.

The term “change information of the emotion state” refers to data indicating a temporal difference between two or more emotion states of a user, such as changes in emotion categories or intensities before and after presentation of answer information.

The term “context information” refers to combined information including user attribute information, situation information, and other environmental or session-related data that influences interpretation of a question or generation of an answer.

The term “role information of the user” refers to user attribute information indicating a functional position or responsibility of a user, such as employee type, customer type, or access level.

The term “work type information” refers to user attribute or context data indicating a category of tasks, business operations, or domains relevant to a user's question.

The term “usage place information” refers to data indicating a physical or logical location associated with a user or a terminal device at a time of interaction, such as a store, office, or remote environment.

The term “semantic similarity index” refers to a numerical value representing similarity in meaning between two text segments, computed using a semantic representation such as embeddings or language model outputs.

The term “feature-term coverage index” refers to a numerical value indicating the degree to which feature terms extracted from question information are present or addressed in answer candidate pieces of information.

The term “sentence-length index” refers to a numerical value representing a length characteristic of text, such as a count of characters, tokens, or sentences, used as a feature in evaluating answer candidates.

The term “readability index” refers to a numerical value indicating how easily a text can be read and understood, computed by applying a readability formula or heuristic to an answer candidate.

The term “improvement-prediction index for the emotion state” refers to a predicted quantitative measure representing how much a particular answer candidate is expected to improve or stabilize a user's emotion state.

The term “evaluation value” refers to a numerical score computed by a learning processing algorithm for each answer candidate piece of information based on feature values, which is used to select an optimal answer information.

In one embodiment, a server cooperates with one or more terminal devices to implement the claimed system. The server includes at least one processor, a main memory, a non-volatile storage device, and a network interface. The terminal includes at least one processor, a memory, a display device, at least one input device such as a touchscreen or keyboard, at least one audio input device such as a microphone, and optionally at least one image input device such as a camera and at least one head-mounted display. The server and the terminal are interconnected via a communication network such as a wireless or wired packet network.

The server stores in the storage device a program that, when executed by the processor, causes the processor to perform the functions recited in the claims. The server also stores trained model parameters for a generative AI model, a natural language processing module, an emotion recognition processing module, and a learning processing algorithm that ranks answer candidates. The generative AI model is implemented as a neural network, for example a transformer-based language model including multiple encoder-decoder or decoder-only layers, attention mechanisms, and word embedding layers. The server realizes the model using a generic numerical computation library and a neural network framework, such as a tensor computation library and an automatic differentiation engine. The server may also store parameters for other auxiliary models, such as sentence embedding models used for semantic similarity computation.

The server uses a language processing technique to analyze question information. The server loads a natural language processing library, such as an open-source tokenization and part-of-speech tagging library, into memory at initialization. The server uses the library to perform tokenization, part-of-speech tagging, lemmatization, and syntactic parsing on the question information. The server also uses a statistical or neural entity recognizer to identify entities and domain-specific terms. The server derives feature terms by filtering tokens and entities using statistical measures such as term frequency-inverse document frequency or using learned attention weights from a sentence encoder. The server stores the feature terms in a structured in-memory data structure, such as a vector of token identifiers and position indices, and associates the feature terms with the corresponding question information.

The server uses user attribute information, situation information, and emotion state information to construct a context representation. The server stores user attribute information, such as a user role, access level, and historical interaction count, in records in a user profile table in the storage device. The server receives situation information from the terminal, such as a location code, a device type code, and a usage scenario identifier, and maps these to internal context identifiers. The server obtains emotion state information from the emotion recognition processing module. The server combines the feature terms, user attribute information, situation information, and emotion state information into a context vector. The context vector may include one-hot encoded role information, normalized numerical values representing emotion intensities, and binary flags indicating scenario types. The server maintains this context vector in memory for use in prompt construction and candidate evaluation.

The server generates a prompt sentence to be input to the generative AI model. The server constructs the prompt sentence by concatenating template phrases with the question information and the context representation in natural language form. The server maintains a set of prompt templates in the storage device, each associated with a scenario type and user role. For example, when the server receives question information associated with a store customer, the server selects a template that emphasizes concise explanations. When the server receives question information from a new employee, the server selects a template that emphasizes step-by-step explanations.

In one example, when the user is a store customer and the question information is “What is the warranty period of this product?”, the server generates the following prompt sentence: Question: “What is the warranty period of this product?”

Please generate a clear and concise answer for a store customer.

In another example, when the user is a new employee, the question information is “What is the procedure for expense reimbursement?”, and the emotion state indicates confusion and anxiety, the server generates the following prompt sentence:
A new employee asks: “What is the procedure for expense reimbursement?” The employee feels confused and anxious.

Please generate a detailed, step-by-step, and friendly explanation of the procedure, and invite the employee to ask further questions.

In a further example, when the user is a store customer and the question is “What is the return policy for this product?” and the emotion state indicates anxiety, the server generates the following prompt sentence:

Customer question: “What is the return policy for this product?”

Customer emotion: anxious.

Please generate an answer that clearly explains the return period and conditions, reassures the customer, and encourages additional questions.

The server uses these prompt sentences as inputs to the generative AI model. The server encodes the prompt sentence into token identifiers using the tokenizer associated with the generative AI model. The server then passes the token identifiers through the embedding layer and a sequence of transformer layers, each comprising multi-head self-attention sub-layers and feed-forward sub-layers. The server computes, at each layer, linear projections of token embeddings, attention scores, and weighted sums, performing matrix multiplications on hardware units such as a central processing unit or a graphics processing unit. The server obtains an output probability distribution over tokens at each time step and samples or selects the most probable tokens under a configured decoding strategy such as greedy decoding, beam search, or top-k sampling. The server repeats this generation procedure to generate multiple answer candidate sequences for a single prompt sentence, thus producing a plurality of answer candidate pieces of information.

The server calculates an emotion state of the user by using the emotion recognition processing module. The server receives voice information, image information, and text information from the terminal. The server extracts acoustic features such as pitch, energy, and spectral characteristics from voice information using a digital signal processing routine executed on the processor. The server derives facial features such as landmark positions and expression indicators from image information using a convolutional neural network-based face analysis model. The server also uses a sentiment analysis model, for example a recurrent neural network or transformer-based classifier, to derive sentiment scores from text information. The server aggregates these signals into a unified emotion state vector that represents probabilities or intensities for emotion categories such as confusion, anxiety, satisfaction, or neutrality. The server stores the emotion state vector in a dedicated memory region associated with the current dialogue session.

The server generates feature values for each of the plurality of answer candidate pieces of information. The server computes, for each answer candidate, a semantic similarity index between the answer candidate and the question information by encoding both the question information and the answer candidate into sentence embedding vectors with a sentence encoder model and computing a cosine similarity value. The server computes a feature-term coverage index by counting the number of feature terms present in the answer candidate and normalizing by the number of feature terms extracted from the question information. The server computes a sentence-length index by determining the token count or character count of the answer candidate. The server computes a readability index by applying a readability formula based on sentence length and word complexity. The server computes an improvement-prediction index by applying a prediction model that estimates how the user's emotion state will change if this answer candidate is presented. This prediction model can be implemented as a feed-forward neural network trained on historical data correlating answer features with observed emotion changes. The server stores these feature values in an array or table, with each row corresponding to one answer candidate and each column corresponding to a different feature.

The server evaluates the plurality of answer candidate pieces of information using the learning processing algorithm. In one embodiment, the learning processing algorithm is a gradient-boosted decision tree model or a neural ranking model implemented using a machine-learning library. The server loads the model parameters from the storage device into memory. The server feeds the feature values for each answer candidate into the model, which computes an evaluation value that reflects an estimated overall quality, including relevance, clarity, and predicted emotion improvement. The server compares the evaluation values for all candidates and selects the candidate with the highest evaluation value as the optimal answer information. The server records the index of the selected candidate and the associated feature vector for logging and further training. The server generates modified answer information when refinement is needed based on the emotion state. When the emotion state indicates that the user is confused, anxious, or dissatisfied, the server constructs an additional prompt sentence that includes the optimal answer information and the emotion state as context. The server uses a template such as:

User question: “(original question)”

Base answer: “(optimal answer)”

User emotion: “(description of emotion state)”.

Please rewrite this answer in a more detailed, step-by-step, and reassuring tone, and invite the user to ask follow-up questions.

The server tokenizes and encodes this additional prompt sentence and passes it through the same generative AI model. The server thereby obtains modified answer information whose tone and level of detail have been adjusted in a systematic way by the model under the control of the additional prompt sentence. The server stores the modified answer information in memory as the final answer for the current interaction.

The server transmits the modified answer information to the terminal device. The server formats the modified answer information as a response message that may additionally include meta-information such as the predicted improvement in emotion state and the evaluation value. The server sends the response message over the communication network using a communication protocol, and it records a log of the transmitted answer in the storage device.

The terminal presents the modified answer information to the user. The terminal, upon receiving the response message from the server, writes the modified answer information to a display buffer and renders it on the display device. If the user prefers audio output, the terminal uses a text-to-speech engine to synthesize speech from the modified answer information, generating digital audio samples that are output through the audio output device. When the terminal is implemented as a head-mounted display, the terminal overlays the modified answer information in the user's field of view. The terminal may also adjust font size or layout based on user attribute information or situation information. The server calculates the emotion state again after the modified answer information is presented. The terminal may capture a post-answer utterance or facial expression and send new voice information or image information to the server. The server repeats the emotion recognition processing, computes a second emotion state vector, and derives change information of the emotion state by subtracting or otherwise comparing the pre-answer and post-answer emotion vectors. The server stores both the pre-answer and post-answer emotion vectors and the change information in the storage device as part of the dialogue history information.

The server updates the learning processing algorithm and the processing for generating the prompt sentence using the stored dialogue history information and the change information of the emotion state. The server periodically retrieves logged examples of question information, context representations, answer candidate feature values, evaluation values, chosen answers, and observed emotion changes. The server uses this dataset to retrain or fine-tune the ranking model and the improvement-prediction model, adjusting model parameters by minimizing a loss function such as mean squared error between predicted and observed emotion change, or a ranking loss function such as pairwise hinge loss between evaluation values of successful and unsuccessful candidates. The server performs weight updates using an optimization method such as stochastic gradient descent or an adaptive gradient method, and stores the updated model parameters in the storage device. The server also analyzes which prompt template structures correlate with higher emotion improvement and modifies its prompt templates and prompt construction rules accordingly, thereby improving future prompt sentences.

The server thereby improves technical performance in several ways. The server reduces computational waste by guiding the generative AI model with context-rich prompt sentences that constrain the generation space, reducing the number of low-quality candidate sequences that must be evaluated. The server improves answer selection accuracy by using multi-dimensional feature values and a trained ranking model rather than selecting the first generated candidate. The server reduces repeated network traffic and computation by learning which prompt patterns and answer styles are most likely to resolve user confusion in fewer iterations, thus decreasing the number of refinement cycles over time. The server improves data management by storing dialogue history information in a structured format suitable for retraining and analysis, enabling the system to adapt to changing user populations and scenarios. The system's behavior is not a mere automation of human selection; instead, the server uses explicit algorithmic criteria and learned models to evaluate answers in a high-dimensional feature space, which is not feasible for human operators in real time.

The server uses specific neural network architectures and learning methods to achieve these effects. The generative AI model may be a transformer with a fixed number of layers, hidden units, and attention heads, trained on large-scale text corpora with a language modeling objective. The ranking model may be a separate neural network with fully connected layers receiving normalized feature values as input, trained with a supervised learning objective to predict user satisfaction or emotion improvement. The emotion prediction model may share layers with the ranking model or may be implemented separately. The server may perform data augmentation, such as paraphrasing questions or answers, to expand training data and improve generalization. The server's iterative updates to model parameters allow the entire system to improve its technical metrics over time, such as reduced average response latency to an acceptable answer, reduced frequency of clarification requests, and reduced error rate in emotion-improvement predictions.

In another embodiment, the server may offload certain computations to the terminal. The terminal may locally execute a lighter-weight emotion recognition module based on on-device models, providing pre-processed emotion features to the server. The terminal may also cache part of the generative AI model or a distilled version of it to reduce network bandwidth usage for repetitive or simple queries. The server and terminal may cooperate to share computation such that the terminal performs initial feature extraction and the server performs final ranking and refinement.

In a further embodiment, the server may adapt to different hardware configurations. When the server includes a dedicated accelerator such as a graphics processing unit, the server parallelizes matrix multiplications of the generative AI model and the ranking model to improve processing speed. When the server operates only on a central processing unit, the server may use reduced-precision arithmetic or model quantization to achieve acceptable latency. In all cases, the server uses its hardware resources more efficiently by using the ranking model to avoid unnecessary re-generation when the first set of candidates is already sufficient.

In yet another embodiment, the server may support alternative algorithms for some modules. Instead of a transformer-based generative AI model, the server may use a recurrent neural network-based sequence model or a hybrid model combining retrieval-based and generation-based components. Instead of a gradient-boosted tree model for ranking, the server may use a support vector machine or a probabilistic graphical model. Instead of cosine similarity for semantic similarity, the server may use other distance metrics or attention-based similarity. These alternatives remain within the scope of the claimed system as long as the server performs the functions of generating prompt sentences, generating multiple candidate answers, computing feature values including emotion-related indices, selecting an optimal answer using a learning processing algorithm, refining the answer based on emotion, and updating models using dialogue history and emotion change information. By combining these structural and procedural elements, the server, the terminal, and the user cooperate to realize a computer system in which generative AI model behavior is actively controlled and improved through programmatic prompt sentence construction, multi-feature candidate ranking, emotion-aware refinement, and feedback-based retraining. This configuration provides concrete technical improvements in processing efficiency, selection accuracy, and adaptability of the question answering system beyond conventional rule-based or single-pass generative systems.

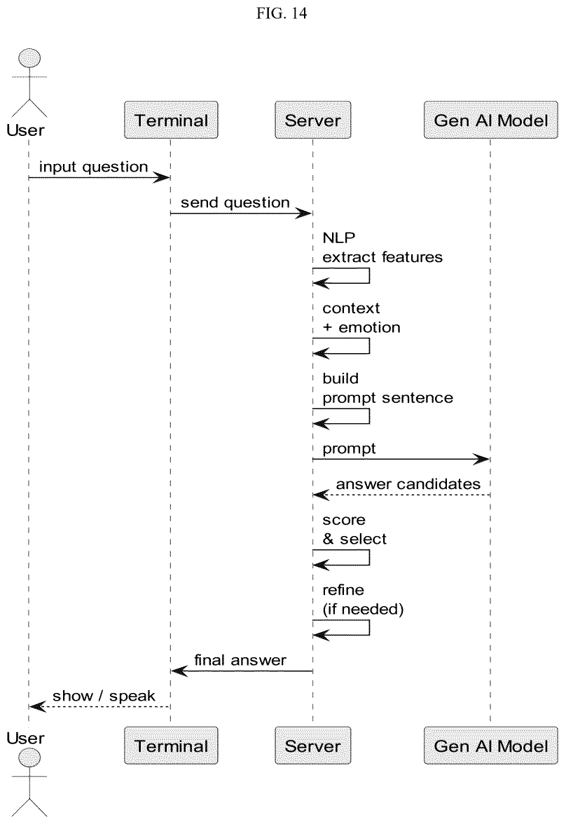

The following describes the processing flow using FIG. 14.

### Step 1

User operates the terminal to input question information.

User uses an input interface of the terminal, such as a keyboard, touchscreen, or microphone, to enter a natural-language question.

Input: a human utterance (speech) or a text string representing the question.

Terminal converts speech, if present, into a digital audio signal by sampling at a given frequency and encoding into a pulse-code modulation or compressed format. Terminal stores the raw text or transcribed text in a temporary buffer together with metadata including a timestamp, a session identifier, and a device identifier.

Output: a structured input object on the terminal containing at least question text and associated metadata.

### Step 2

Terminal transmits the question information to the server.

Terminal packages the input object into a message format such as a structured text document and sends the message to the server via a network protocol.

Input: the input object containing question text and metadata.

Terminal serializes the object into a message body, attaches a destination address for the server, and performs a network send operation over a communication interface such as wireless or wired data link.

Output: a received request message stored in a receive buffer on the server.

### Step 3

Server parses the received request and normalizes the question information.

Server reads the request message from the receive buffer, verifies its format, and extracts the question text, user identifier, and contextual metadata.

Input: the raw request message from the terminal. Server performs parsing by splitting the message according to predefined delimiters or using a structured parser, and maps the fields into an internal data structure stored in main memory.

Server converts character encodings if necessary and removes control characters to normalize the question text.

Output: a normalized question record in memory that includes clean question text, user attribute information (if available), situation information, and a session identifier.

### Step 4

Server applies a language processing technique to extract feature terms.

Server loads a natural language processing module into memory and processes the question text.

Input: the normalized question record containing question text. Server performs tokenization to split the text into tokens, performs part-of-speech tagging to assign grammatical categories, and applies lemmatization to map inflected forms to base forms. Server then filters tokens based on stop-word lists and frequency thresholds and may apply a statistical measure such as term frequency-inverse document frequency to score tokens. Server selects tokens and phrases with scores above a threshold as feature terms.

Output: a feature-term list associated with the question record, stored as a list of token identifiers and positions.

### Step 5

Server constructs a context representation using user attribute information, situation information, and emotion state information.

Server retrieves or receives related context data and assembles them into a structured vector.

Input: the question record, including feature terms, user identifier, and situation metadata; optionally initial emotion state information if available from previous interactions.

Server accesses a user profile table in storage using the user identifier and reads user attribute fields such as role and experience level. Server maps situation metadata such as location code and device type into categorical codes. Server encodes each item into numerical or symbolic features, such as one-hot vectors for role and scenario, and concatenates these with any existing emotion state vector to form a context vector in memory.

Output: a context representation data structure that combines feature terms and contextual features for the current session.

### Step 6

Server calculates an emotion state using an emotion recognition processing module.

Server analyzes available user signals to estimate the emotion state.

Input: at least one of voice information, image information, and text information associated with the user's current interaction.

Server computes acoustic features, such as pitch contour and energy distribution, from voice information using digital signal processing operations, and computes visual features, such as facial landmark positions and expression probabilities, from image information using a pre-trained convolutional neural network. Server also computes text sentiment or emotion probabilities using a classifier that processes the question text. Server concatenates these feature vectors and inputs them into an emotion recognition model, which outputs emotion category probabilities by computing weighted sums and activation functions.

Output: an emotion state vector representing intensities for emotion categories, stored as part of the context representation.

### Step 7:

Server generates a prompt sentence based on the feature terms, context representation, and emotion state.

Server selects and fills a natural-language template to construct a generative AI model input.

Input: the feature-term list, the context representation including user role and situation, and the emotion state vector.

Server selects a prompt template from a template store by matching the user role and scenario type. Server generates natural-language segments that describe the user type and emotion, and inserts the original question text and these segments into the template. Server forms a final prompt sentence string by concatenation and formatting operations.

Output: a prompt sentence stored as a text string ready to be tokenized for the generative AI model.

### Step 8

Server inputs the prompt sentence into a generative AI model to generate multiple answer candidate pieces of information. Server encodes the prompt sentence and executes the generative model. Input: the prompt sentence text.

Server tokenizes the prompt sentence using the tokenizer associated with the generative AI model and converts tokens to numerical identifiers. Server looks up embeddings for each token, and passes the embeddings through multiple layers of a neural network architecture, such as a transformer decoder with self-attention and feed-forward sublayers. At each generation step, server computes probability distributions over possible next tokens by performing matrix multiplications and applying softmax functions. Server uses a decoding algorithm, such as beam search, to generate several distinct sequences of tokens representing different answers. Server converts each token sequence back into text.

Output: a set of answer candidate texts stored as a list of strings in memory.

### Step 9

Server computes feature values for each answer candidate.

Server evaluates each candidate with respect to linguistic and emotion-related metrics.

Input: the set of answer candidate texts, the original question text, the feature-term list, and the emotion state vector.

Server encodes the question and each answer candidate into sentence embeddings using a sentence encoder model, and computes a semantic similarity value between each candidate and the question by applying a cosine similarity function. Server computes a feature-term coverage value by counting feature terms present in each candidate and normalizing by the total number of feature terms. Server computes a sentence-length value based on token counts and a readability value using a formula that uses average sentence length and word complexity. Server further computes an improvement-prediction value by feeding a concatenation of candidate features and emotion features into a prediction network that outputs a scalar estimate.

Output: for each answer candidate, a feature vector containing at least a semantic similarity index, feature-term coverage index, sentence-length index, readability index, and improvement-prediction index.

### Step 10

Server evaluates the answer candidates using a learning processing algorithm and selects optimal answer information.

Server ranks candidates based on their feature vectors.

Input: the list of feature vectors corresponding to the answer candidates.

Server feeds each feature vector into a trained ranking model, such as a gradient-boosted decision tree ensemble or a neural ranking network. The model computes an evaluation value by applying learned weights to the input features and aggregating them through nonlinear activation functions. Server compares the evaluation values for all candidates, identifies the candidate with the highest evaluation value, and marks this candidate as optimal answer information.

Output: a selected optimal answer text and its associated feature vector and evaluation value.

### Step 11

Server determines whether refinement based on emotion is required and, if necessary, generates an additional prompt sentence.

Server decides on iterative refinement based on the emotion state and evaluation results.

Input: the optimal answer text, the emotion state vector, and optionally thresholds or policies stored in configuration data.

Server evaluates whether the emotion state vector indicates confusion or anxiety above a threshold or whether the evaluation value suggests that a more detailed or softer tone is beneficial. If refinement is needed, server constructs an additional prompt sentence by combining the original question, the optimal answer, and a natural-language description of the user's emotion. Server chooses a refinement template and fills it with these segments, producing a new prompt sentence that instructs the generative AI model to adjust tone and detail.

Output: either the original optimal answer text (if no refinement is needed) or an additional prompt sentence for refinement.

### Step 12

Server generates modified answer information using the generative AI model with the additional prompt sentence.

Server performs a second generation pass when refinement is selected.

Input: the additional prompt sentence and the optimal answer text.

Server tokenizes and encodes the additional prompt sentence, passes it through the same generative AI model, and generates a new answer sequence using a decoding strategy that encourages elaboration and politeness, for example by adjusting sampling temperature or length penalties. Server converts the generated token sequence into text, which becomes modified answer information that reflects the requested adjustments in tone and level of detail.

Output: a modified answer text stored as the final answer for the session.

### Step 13

Server transmits the final answer to the terminal and logs dialogue history.

Server prepares a response and records interaction data.

Input: the final answer text (either optimal or modified), the question record, the feature vectors, and the emotion state vector.

Server constructs a response message containing the final answer text and any auxiliary data required by the terminal. Server sends this message to the terminal via the network interface. Server also creates a dialogue history record comprising the question text, feature terms, prompt sentences used, answer candidates, selected answer, emotion state before answer, and computed feature values, and writes this record to a storage device.

Output: a response message stored in the terminal's receive buffer, and a persistent dialogue history record in server storage.

### Step 14

Terminal presents the final answer to the user.

Terminal converts the received answer into a user-visible or audible form.

Input: the response message containing the final answer text.

Terminal extracts the final answer text, writes it into a display buffer, and renders it on the display device as a text region, chat bubble, or overlay. If audio output is configured, terminal sends the final answer text to a text-to-speech engine, receives synthesized audio samples, and outputs the samples through the audio output device. Terminal may also adjust presentation style, such as font size or on-screen position, based on device capabilities and user preferences.

Output: a visual or auditory presentation of the final answer perceived by the user.

### Step 15

User provides follow-up input, and terminal captures post-answer signals.

User reacts to the presented answer, which the terminal records.

Input: user behavior after the answer, such as a follow-up utterance, a facial expression, or an explicit feedback input.

Terminal captures additional voice information, image information, or explicit rating inputs, and packages these into a follow-up message. Terminal associates the follow-up message with the existing session identifier and transmits it to the server for further processing or logging.

Output: a follow-up message on the server containing post-answer user signals.

### Step 16

Server updates emotion state and calculates change information.

Server compares pre-answer and post-answer emotion estimates.

Input: the follow-up user signals and the stored pre-answer emotion state vector. Server applies the emotion recognition processing module again to the new signals and obtains a post-answer emotion state vector. Server computes change information by subtracting or otherwise comparing the pre-answer and post-answer emotion vectors, deriving values that indicate increases or decreases in confusion, anxiety, or satisfaction.

Server appends the change information to the dialogue history record in storage.

Output: an updated dialogue history entry including emotion change information.

### Step 17

Server retrains or adjusts the learning processing algorithm and prompt generation logic based on accumulated history.

Server periodically uses stored data to improve internal models.

Input: a collection of dialogue history records containing questions, feature terms, prompt sentences, answer candidates, selected answers, emotion states, and emotion change information.

Server constructs a training dataset by extracting feature vectors and labels, such as success indicators or measured emotion improvements, from the history records. Server feeds this dataset into the learning processing algorithm's training procedure, computes prediction errors for the current model, and updates model parameters using an optimization algorithm.

Server stores new model parameters in the storage device and replaces older parameters in memory. Server also analyzes statistics of successful interactions to modify or add prompt templates and refine rules that map context and emotion states to prompt sentences.

Output: updated model parameters and revised prompt generation rules that will be used in subsequent executions of earlier steps.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

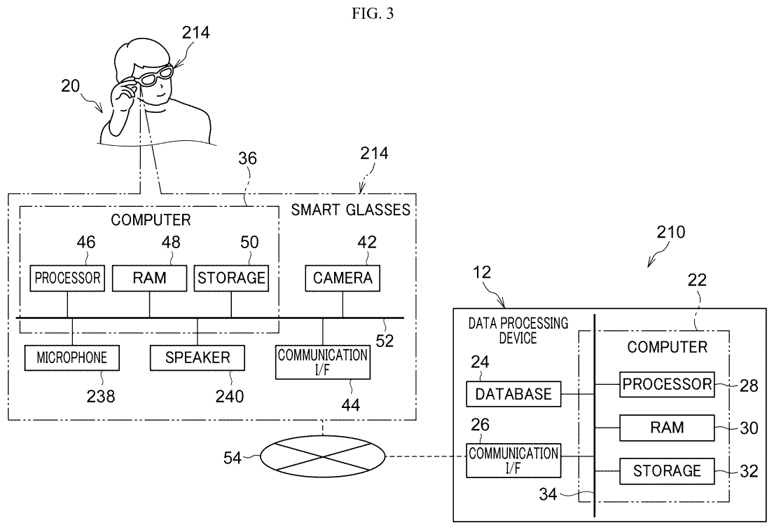

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

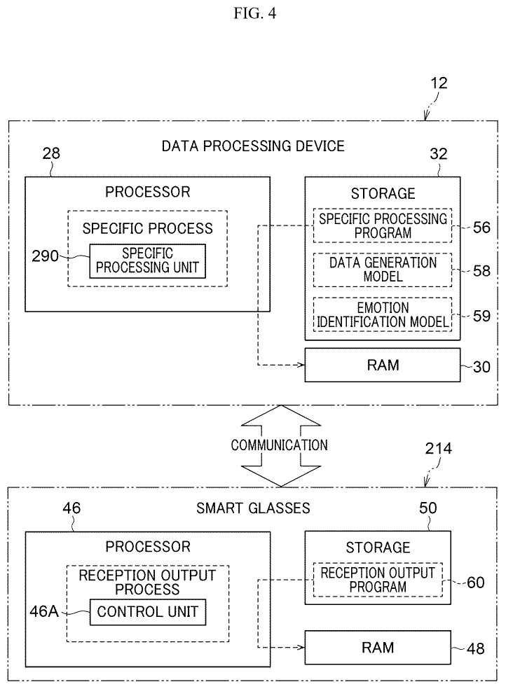

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

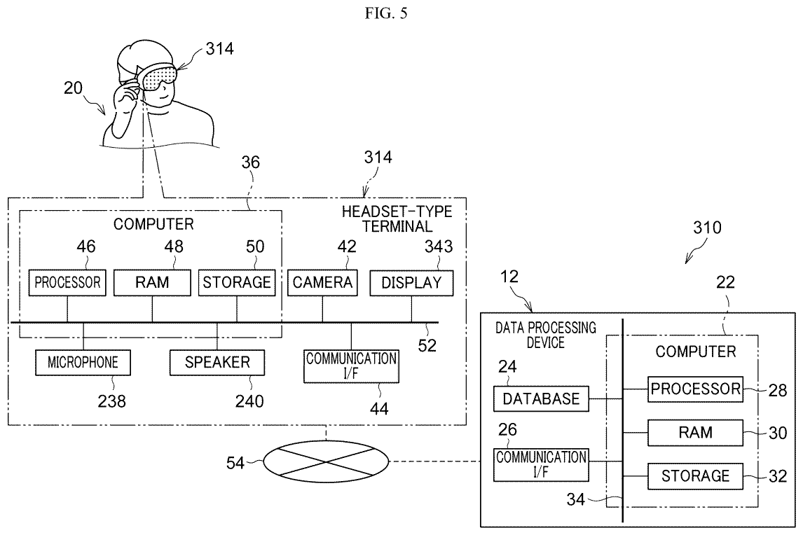

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

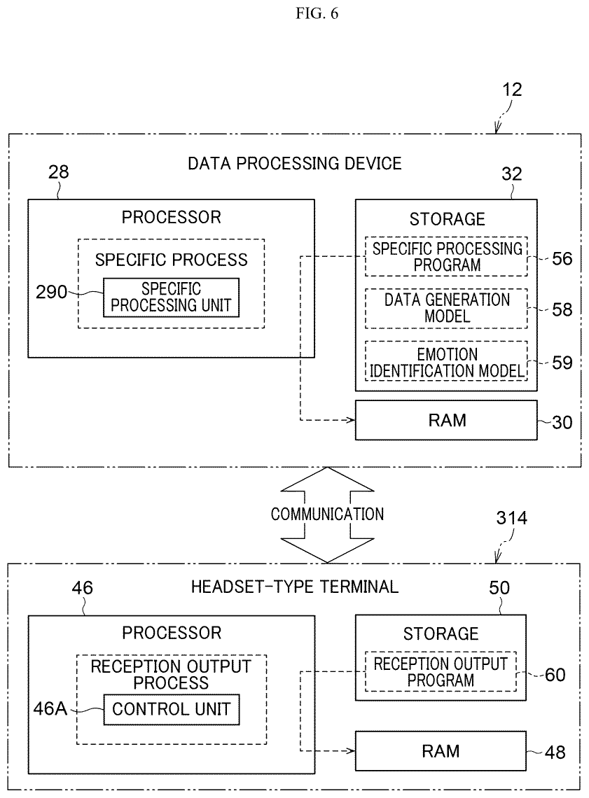

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

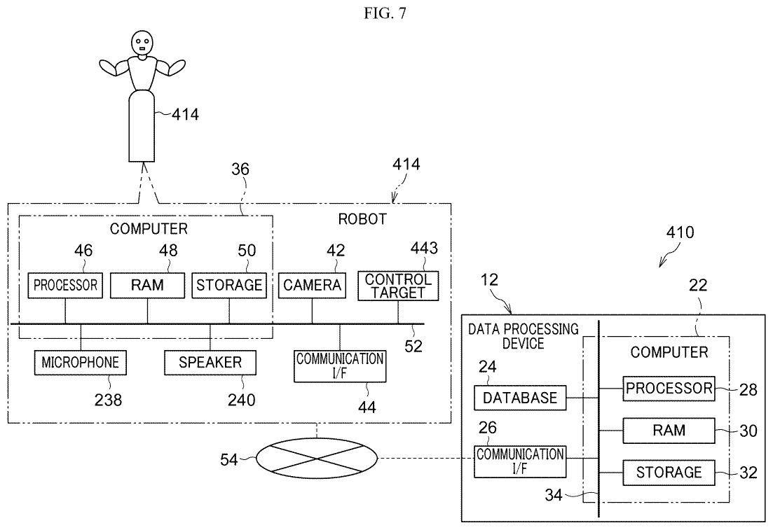

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

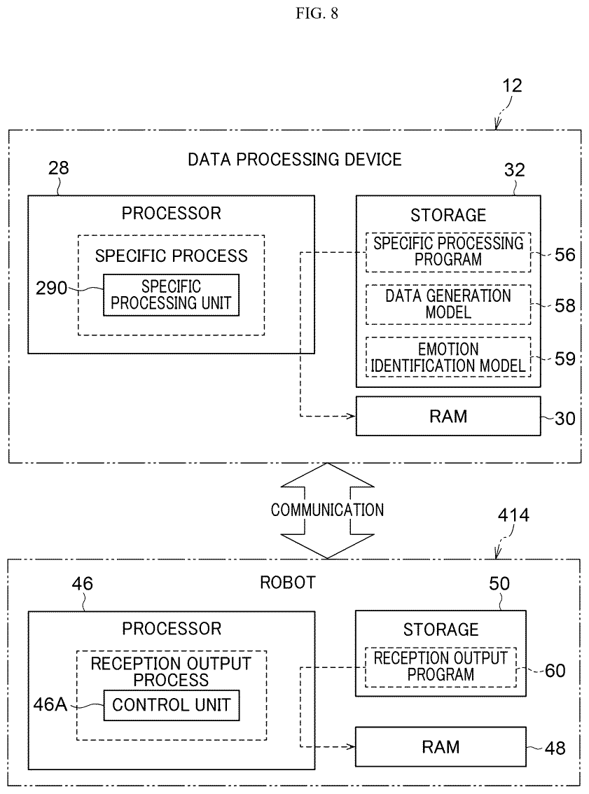

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

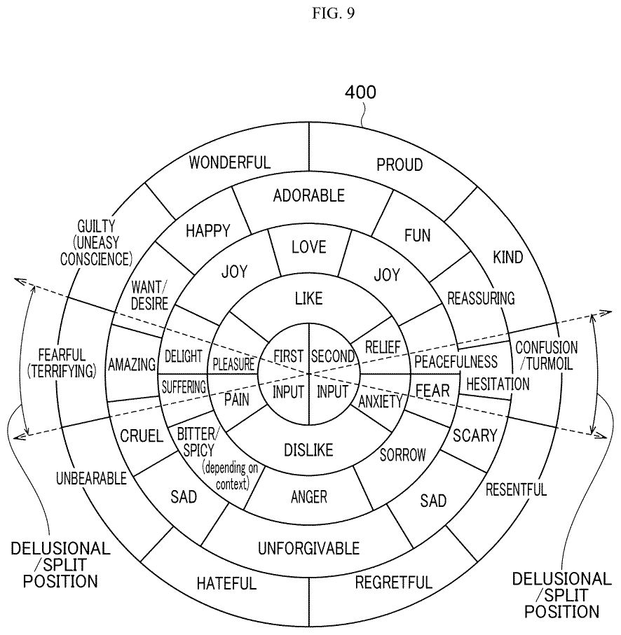

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

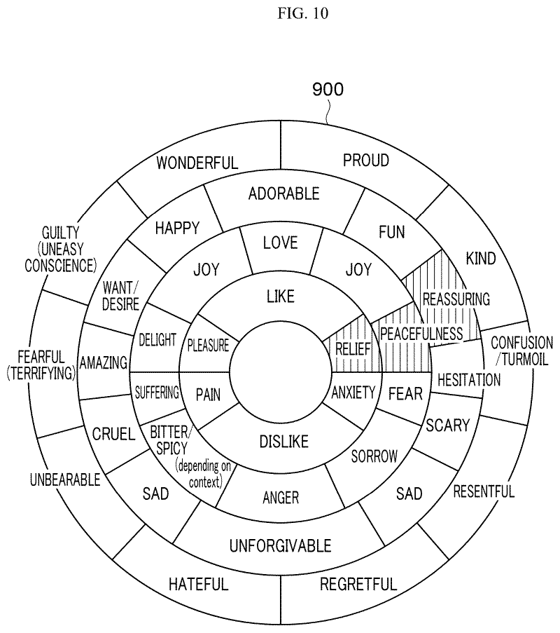

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via an input device, a question expressed in a natural language from a user and acquire the question as character information,
generate communication data including the acquired question and transmit the communication data to a server via a communication network,
cause the server to extract the question from the communication data and construct a prompt sentence including an instruction text defining conditions for answer generation for the question and the question, and input the prompt sentence to a generative AI model, cause the generative AI model to perform natural language processing using the prompt sentence as input and generate character information representing an answer candidate to the question,
cause the server to generate response data including the generated answer candidate and transmit the response data to the input device via the communication network, cause the input device to extract the answer candidate from the response data and present the answer candidate to the user via a display device, and
cause the server to apply a machine learning algorithm based on the generated answer candidate and the question to obtain evaluation information of the answer candidate and control an output format of the answer candidate based on the evaluation information.

### (Supplementary 2)

The system according to supplementary 1,
wherein the processor is configured to cause the server to store, in a storage device as history information, a plurality of questions received from the input device and a plurality of answer candidates generated by the generative AI model for the respective questions, and construct the prompt sentence by incorporating a plurality of message sequences including the history information into the prompt sentence to input to the generative AI model so that the generative AI model generates the answer candidate corresponding to the question in accordance with a conversational context.

### (Supplementary 3)

The system according to supplementary 1,
wherein the processor is configured to cause the input device to display, on a user interface, the answer candidate received from the server together with identification information indicating that the answer candidate is generated by the generative AI model and the evaluation information calculated by the machine learning algorithm, so that the user is enabled to utilize the answer candidate with reference to the evaluation information.

### Application Example 1

### (Supplementary 1)

A system comprising a processor,
wherein the processor is configured to
receive audio information transmitted from a terminal that accepts a voice question from a user, and execute speech recognition processing on the audio information to generate audio text information,
receive visual information transmitted from the terminal, the visual information being acquired by an imaging device, execute image recognition processing on the visual information to extract object information, and acquire task-related information stored in a storage device on the basis of the object information,
generate a prompt sentence to be input to a generative AI model on the basis of the audio text information and the task-related information, input the prompt sentence to the generative AI model, and cause the generative AI model to generate answer candidate information,
evaluate the answer candidate information on the basis of the answer candidate information and attribute information associated with the user by using natural language processing and a machine learning algorithm, and select answer information to be presented to the user, and transmit the answer information and the task-related information to the terminal and convert the answer information and the task-related information into a format displayable in superimposition on a display device of the terminal.

### (Supplementary 2)

The system according to supplementary 1,
wherein the processor is configured to
estimate a work situation in which the user is currently engaged on the basis of the audio text information and the object information extracted from the visual information, and
automatically adjust content of the prompt sentence and a representation format of the answer information in accordance with the work situation.

### (Supplementary 3)

The system according to supplementary 1,
wherein the processor is configured to
store, in time series, the visual information and the audio information transmitted from the terminal, and update, on the basis of stored information, the machine learning algorithm and processing for generating the prompt sentence for the generative AI model, thereby sequentially improving the answer information presented to the user.

### Example 2

### (Supplementary 1)

A system comprising a processor,
wherein the processor is configured to
receive a natural-language question input by a user via a terminal, and perform character-string normalization processing and natural-language processing on the question to analyze the question and extract structured information including an intent of the question and important terms,
select, based on the structured information, a template corresponding to the intent and a topic of the question, and generate a prompt sentence to be input to a generative AI model by embedding the structured information into the template,
input the generated prompt sentence to an internal or external generative AI model via a communication interface and cause the generative AI model to generate at least one answer candidate based on the prompt sentence,
perform post-processing on the generated answer candidate, the post-processing including at least one of formatting processing, information-structuring processing, and length-control processing, to generate answer data presentable to the user,
transmit the answer data to the terminal and provide an answer to the question to the user by causing the terminal to display the answer data, and
store, in association with the question, the prompt sentence, and the answer data, evaluation information or feedback information obtained from the user, and update, based on stored contents, at least one of a generation logic of the prompt sentence and an operation parameter of the generative AI model by using a machine-learning algorithm so as to improve answer generation performance for subsequent questions.

### (Supplementary 2)

The system according to supplementary 1,
wherein the processor is configured to
generate the prompt sentence by selecting different prompt templates according to an intent-classification result and a topic-classification result for the question, and by inserting, into the selected prompt template, text including an original wording of the question of the user and the important terms, so that the generative AI model generates an answer taking into account a context of the question and a user attribute.

### (Supplementary 3)

The system according to supplementary 1,
wherein the processor is configured to
obtain a plurality of answer candidates by inputting, to the generative AI model, a plurality of mutually different prompt sentences based on identical structured information, evaluate the plurality of answer candidates based on at least one of the question content, the user attribute, and past evaluation information by using the machine-learning algorithm, and select, based on a result of the evaluation, an optimal answer candidate as the answer data.

### Application Example 2

### (Supplementary 1)

A system comprising a processor,
wherein the processor is configured to
receive question information from a user and analyze the question information by using a language processing technique to extract feature terms from the question information,
generate a prompt sentence, which is an instruction sentence to be input to a generative AI model, on the basis of the feature terms, user attribute information, situation information, and emotion state information, and input the prompt sentence to the generative AI model so as to cause the generative AI model to generate a plurality of answer candidate pieces of information,
calculate an emotion state of the user by using an emotion recognition processing module on the basis of at least one of voice information, image information, and text information of the user, g
enerate feature values on the basis of the plurality of answer candidate pieces of information, the emotion state, and past dialogue history information, evaluate the plurality of answer candidate pieces of information by using a learning processing algorithm, and select optimal answer information,
generate, on the basis of the optimal answer information and the emotion state, a modified answer information in which tone and detail level of the optimal answer information are adjusted, by inputting an additional prompt sentence to the generative AI model,
transmit the modified answer information to a terminal device, present the modified answer information to the user through a display device or an audio output device, calculate the emotion state of the user again after the presentation, and store change information of the emotion state as dialogue history information in a storage device, and
update the learning processing algorithm and processing for generating the prompt sentence on the basis of the stored dialogue history information and the change information of the emotion state.

### (supplementary 2)

The system according to supplementary 1,
wherein the processor is configured to, in the processing for generating the prompt sentence, add instruction content to the prompt sentence so as to include, in addition to the feature terms extracted from the question information, context information including role information of the user, work type information, and usage place information, and thereby specify explanation level, politeness, and prompting of follow-up questions for an answer to be generated by the generative AI model.

### (Supplementary 3)

The system according to supplementary 1,
wherein the processor is configured to cause the learning processing algorithm to generate, for each of the plurality of answer candidate pieces of information, feature values including a semantic similarity index, a feature-term coverage index, a sentence-length index, a readability index, and an improvement-prediction index for the emotion state, calculate an evaluation value of each answer candidate piece of information on the basis of the feature values, and select, as the optimal answer information, the answer candidate piece of information having a maximum evaluation value.

What is claimed is:

1. A system comprising:
circuitry configured to:
receive, via a communication interface coupled to a packet-switched network, communication data comprising a natural language question from a terminal device;
extract, by applying a natural language processing algorithm to the natural language question, one or more keyword terms, and construct a prompt sentence encoding the keyword terms, instruction text defining answer generation conditions, and a plurality of message sequences representing dialogue history comprising prior questions and prior answer candidates;
input the prompt sentence to a generative neural network model, and receive one or more answer candidates generated by the generative neural network model;
apply a machine learning algorithm to the natural language question and each answer candidate to calculate evaluation information representing a quality score or a suitability score for each answer candidate;
analyze an emotional state of a user using an emotion engine configured to recognize an emotion of the user from input data received from the terminal device; and
select an optimal answer from the one or more answer candidates based on the evaluation information and the emotional state, and transmit response data comprising the optimal answer and the evaluation information to the terminal device via the communication interface.

2. The system according to claim 1, wherein the circuitry is configured to construct the prompt sentence by encoding the natural language question, the keyword terms, and the message sequences as a structured input sequence, and appending the instruction text as a system-level directive that constrains a generation style of the generative neural network model.

3. The system according to claim 2, wherein the circuitry is configured to apply a tokenization algorithm to the structured input sequence to generate a token identifier sequence, and to truncate the message sequences based on a context window length parameter when the token identifier sequence exceeds the context window length parameter.

4. The system according to claim 2, wherein the natural language question comprises a user inquiry directed at an information service, the dialogue history comprises prior user questions and corresponding answer candidates stored in association with a session identifier, and the answer generation conditions specify a response format and a maximum output length.

5. The system according to claim 4, wherein the response data comprises the optimal answer, a model identification label, and the evaluation information, and the circuitry is configured to transmit the response data to the terminal device for display via a user interface.

6. The system according to claim 1, wherein the circuitry is configured to apply the machine learning algorithm by computing a semantic similarity score between an embedding vector of the natural language question and an embedding vector of each answer candidate, and combining the semantic similarity score with a fluency score derived from a language model perplexity measure to generate the evaluation information.

7. The system according to claim 6, wherein the circuitry is configured to compute the embedding vectors by applying a transformer-based encoder to the natural language question and each answer candidate, and to compute the semantic similarity score using a cosine similarity metric.

8. The system according to claim 1, wherein the circuitry is configured to analyze the emotional state of the user by applying the emotion engine to at least one of voice data, text expressions, or interaction timing data received from the terminal device to output a probability distribution over a plurality of emotional state categories.

9. The system according to claim 8, wherein the circuitry is configured to select the optimal answer by applying a selection criterion that combines the evaluation information with the probability distribution, such that for a high-distress emotional state, the circuitry applies a higher weight to answer candidates with higher fluency scores, and for a neutral emotional state, the circuitry applies a higher weight to answer candidates with higher semantic similarity scores.

10. The system according to claim 1, wherein the circuitry is configured to store the optimal answer and the natural language question in the storage device as a new entry in the dialogue history associated with a session identifier, and to include the new entry in a subsequent prompt sentence to maintain multi-turn context.

11. The system according to claim 10, wherein the circuitry is configured to update the dialogue history by associating each stored entry with a turn identifier and a timestamp, and to apply a recency-based selection criterion to select a subset of dialogue history entries for inclusion in the subsequent prompt sentence.

12. The system according to claim 1, wherein the circuitry is configured to generate the one or more answer candidates by executing the generative neural network model a plurality of times using different sampling temperatures, and to assign each answer candidate a distinct candidate identifier for use in the machine learning algorithm evaluation.

13. The system according to claim 12, wherein the circuitry is configured to apply the machine learning algorithm to rank the answer candidates by evaluation information score, and to transmit the top-ranked answer candidate as the optimal answer together with a ranked list of the remaining candidates and their evaluation information scores.

14. The system according to claim 1, wherein the circuitry is configured to extract the keyword terms from the natural language question by applying a term frequency-inverse document frequency weighting to tokenized terms in the natural language question, and selecting terms exceeding a relevance threshold as the keyword terms.

15. The system according to claim 1, wherein the circuitry is configured to generate the response data by encoding the optimal answer, an answer source identifier, and the evaluation information as structured fields in a response payload, and transmitting the response payload to the terminal device via the communication interface.

16. The system according to claim 1, wherein the circuitry is configured to apply a retrieval-augmented generation pipeline by querying a vector database using an embedding vector derived from the keyword terms to retrieve reference documents, and incorporating the reference documents into the prompt sentence.

17. The system according to claim 1, wherein the circuitry is configured to update model parameters of the machine learning algorithm based on user feedback data received from the terminal device, wherein the user feedback data comprises an approval or correction associated with the optimal answer.

18. A system comprising:
circuitry configured to:
receive, via a communication interface coupled to a packet-switched network, communication data comprising a natural language question from a terminal device;
extract keyword terms from the natural language question using a natural language processing algorithm, and construct a prompt sentence encoding the keyword terms, instruction text, and a plurality of message sequences representing dialogue history;
input the prompt sentence to a generative neural network model to generate a plurality of answer candidates;
apply a machine learning algorithm to compute a quality score for each answer candidate by measuring semantic similarity between the natural language question and each answer candidate using embedding vectors and a similarity metric;
analyze an emotional state of a user from input data received from the terminal device using an emotion engine, and select an optimal answer from the plurality of answer candidates based on the quality scores and the emotional state; and
transmit response data comprising the optimal answer and the quality scores to the terminal device via the communication interface.

19. The system according to claim 18, wherein the circuitry is configured to compute the embedding vectors by applying a transformer-based encoder to the natural language question and each answer candidate, and to apply a cosine similarity metric to generate the quality scores.

20. A method comprising:
receiving, via a communication interface coupled to a packet-switched network, communication data comprising a natural language question from a terminal device;
extracting, by applying a natural language processing algorithm to the natural language question, one or more keyword terms, and constructing a prompt sentence encoding the keyword terms, instruction text defining answer generation conditions, and a plurality of message sequences representing dialogue history comprising prior questions and prior answer candidates;
inputting the prompt sentence to a generative neural network model, and receiving one or more answer candidates generated by the generative neural network model;
applying a machine learning algorithm to the natural language question and each answer candidate to calculate evaluation information representing a quality score or a suitability score for each answer candidate;
analyzing an emotional state of a user using an emotion engine configured to recognize an emotion of the user from input data received from the terminal device; and
selecting an optimal answer from the one or more answer candidates based on the evaluation information and the emotional state, and transmitting response data comprising the optimal answer and the evaluation information to the terminal device via the communication interface.
